(19) United States
(12) Patent Application Publication
(10) Pub. No.: US 2024/0371138 A1
(43) Pub. Date: Nov. 7, 2024

(54) INSPECTION TOOL INCLUDING AUTOMATIC FEATURE DETECTION AND CLASSIFICATION

(71) Applicant: MILWAUKEE ELECTRIC TOOL CORPORATION, Brookfield, WI (US)

(72) Inventors: Kathleen M. Keegan, Milwaukee, WI (US); Paige Lincoln, Menomonee Falls, WI (US); Jonathan E. Abbott, Milwaukee, WI (US); Christian U. Martinez, Genoa City, WI (US); Daniel E. Endean, Hartland, WI (US)

(21) Appl. No.: 18/568,753

(22) PCT Filed: Jun. 15, 2022
(86) PCT No.: PCT/US22/33663

§ 371 Date: Dec. 8, 2023

Related U.S. Application Data
(60) Provisional application No. 63/210,839, filed on Jun. 15, 2021.

(51) Int. Cl. G06V 10/764; G06V 20/70; H04N 23/61

(52) U.S. Cl. CPC G06V 10/765; G06V 20/70; H04N 23/61

(57) ABSTRACT

Systems and methods for determining a classification from image data. In an embodiment, an object-based audio data processing system includes a processor configured to receive, from an inspection camera, image data collected from an area of interest, process the image data through a model to determine a classification for an aspect of the area of interest, the model trained with previously received image data and respective previously received or determined classifications, determine, based on the classification, a label for the aspect, and provide the label and the image data to a user interface

### RELATED APPLICATIONS

This application claims the benefit of U.S. Provisional Patent Application No. 63/210,839, filed Jun. 15, 2021, the entire content of which is hereby incorporated by reference.

### BACKGROUND

Inspection tools include various types of equipment used to perform non-destructive testing (NDT) to collect information about the condition of a particular system.

### SUMMARY

Inspection tools may include a control system and various sensors, such as cameras, transducer, thermometers, and pressure meters. For example, pipeline inspection tools fit inside pipes and can be employed to identify clogs and breakages as well as pipe aspects such as materials, joints, estimates of slope, and so forth. Other inspection tools can be employed to view various aspects and environments on a construction site such as behind structures or wall during a remodeling. Still other inspection tools can be employed to view aspects of a motor (e.g., automotive) or electrical work (e.g., routing wiring through walls and electrical conduit). Many inspection tools allow users to manually input labels via, for example, a display or monitor connected (wired or wirelessly) an inspection system (e.g., a control hub or holder).

Accordingly, embodiments of the present disclosure are generally directed various inspection tools and systems in which a machine learning classifier is employed to classify information collected via the various sensors. In some embodiments, the machine learning classifier processes data received from a camera to determine a label to apply to an object or various aspects of the environment.

For example, an inspection tool configured to collect and processes information from a pipe may employ various sensors such as a camera, which can be inserted into the pipe. In some embodiments, the machine learning classifier processes the collected data (e.g., image data) received from the sensors to determine and label, for example, the type of pipe (e.g., polyvinyl chloride (PVC), copper, black pipe, and so forth) as well as path aspects (e.g., turns, connections with other pipes, slopes, and so forth). In some embodiments, the machine learning classifier may processes the collected data to determine and label other aspects of the pipe or path, such as clogs, cracks, roots, fluid build-up, fluid running, wear, transitions, connecting pipes, joints, offset joints, misalignment, inner linings, bellied pipe, leaks, change in material (e.g., type of pipe changes from copper to black), and so forth.

As another example, an inspection tool may be configured to collect and processes information in a construction site to determine/detect and label, for example, wires, studs, nails, cracks, daylight, pipes, hoses, outlets, screws, material layers, turns and connections for pipes, and so forth. In another example, an inspection tool may be configured to collect and processes information from a motor or other type of industrial machine to determine/detect and label, for example, cracks, scratches, defects, wear, leaks, dropped sockets (especially the 10 mm socket), and so forth. In another example, an inspection tool may be configured to collect and processes information for fish tape or electrical use to determine/detect and label, for example, junction boxes, turns, connections, daylight, and so forth. Other examples include use of an inspection tool to assist with cleaning drains and pipes, pipe lining, internal pipe welding and cutting (e.g., via a plasma cutting), and so forth. In some examples, the inspection tool may be untethered and remotely, semi-autonomously, or autonomously controlled.

It is appreciated that methods in accordance with the present disclosure can include any combination of the aspects and features described herein. That is, methods in accordance with the present disclosure are not limited to the combinations of aspects and features specifically described herein, but also may include any combination of the aspects and features provided.

The details of one or more implementations of the present disclosure are set forth in the accompanying drawings and the description below. Other features and advantages of the present disclosure will be apparent from the description and drawings, and from the claims.

Before any embodiments are explained in detail, it is to be understood that the disclosure is not limited in its application to the details of construction and the arrangement of components set forth in the following description or illustrated in the following drawings. Aspects of this disclosure are capable of other embodiments and of being practiced or of being carried out in various ways. Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected,” “supported by,” and “coupled” are used broadly and encompass both direct and indirect mounting, connecting and coupling. Further, “connected” and “coupled” are not restricted to physical or mechanical connections or couplings, and can include electrical connections or couplings, whether direct or indirect. As used in this disclosure and the appended claims, the singular forms “a,” “an,” and “the” include plural references unless the context clearly dictates otherwise. Any reference to “or” herein is intended to encompass “and/of” unless otherwise stated.

It should be noted that a plurality of hardware and software-based devices, as well as a plurality of different structural components may be utilized to implement aspects of this disclosure. Furthermore, and as described in subsequent paragraphs, the specific configurations illustrated in the drawings are intended to exemplify embodiments of the disclosure and that other alternative configurations are possible. The terms “processor” “central processing unit” and “CPU” are interchangeable unless otherwise stated. Where the terms “processor” or “central processing unit” or “CPU” are used as identifying a unit performing specific functions, it should be understood that, unless otherwise stated, those functions can be carried out by a single processor, or multiple processors arranged in any form, including parallel processors, serial processors, tandem processors or cloud processing/cloud computing configurations.

As used herein, the term “real-time” refers to transmitting or processing data without intentional delay given the processing limitations of a system, the time required to accurately obtain data and images, and the rate of change of the data and images. In some examples, “real-time” is used to describe the presentation of information obtained from components of embodiments of the present disclosure.

### BRIEF DESCRIPTION OF DRAWINGS

FIG. 1 illustrates a first inspection tool system, according to embodiments described herein.

FIG. 2 illustrates a second inspection tool system, according to embodiments described herein.

FIG. 3 illustrates a third inspection tool system, according to embodiments described herein.

FIGS. 4A-B illustrate a fourth inspection tool system, according to embodiments described herein.

FIG. 4C illustrates a fourth inspection tool system, according to embodiments described herein.

FIG. 5A is a block diagram of an example inspection tool of the inspection tool systems of FIGS. 1-4C, according to embodiments described herein.

FIG. 5B is a block diagram of a machine learning controller of the power tool of FIG. 5A, according to embodiments described herein.

FIGS. 6A and 6B depict flow diagrams of example processes that can be employed within an inspection tool system, according to embodiments described herein.

### DETAILED DESCRIPTION

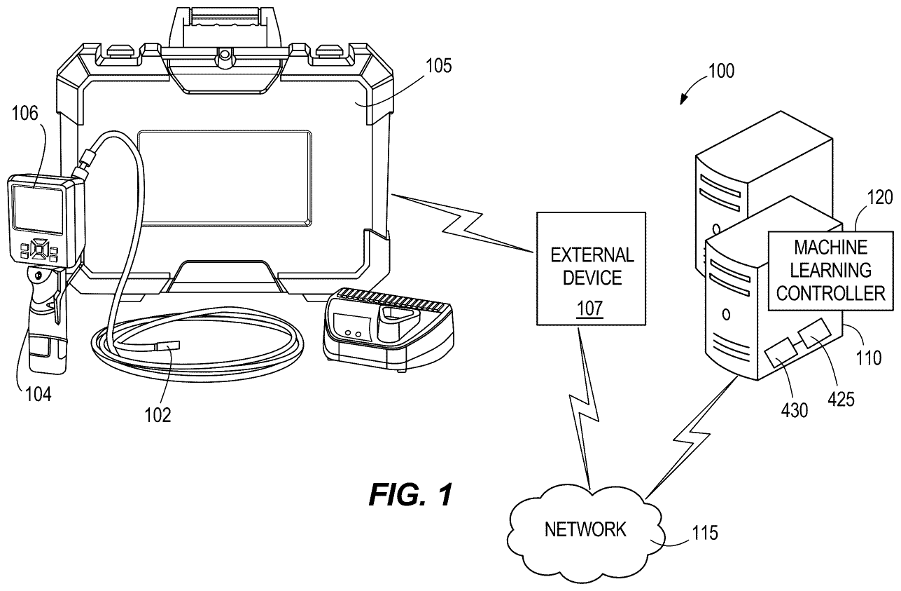

FIG. 1 illustrates a first inspection tool system 100. The first inspection tool system 100 includes an inspection tool 105 having at least one sensor 102, a housing 104, a display or user interface 106, an external device 107, a server 110, and a network 115. The sensor 102 collects environment data during the operation of the inspection tool 105. The environment data refers to, for example, data regarding the environment within which the sensor 102 has been placed. For example, the sensor 102 may be positioned inside a pipe or tube, behind structures, inside a machines or motor, and so forth, and employed to collect data such as images, temperature readings, pressure reading, positional information, and so forth from the deployed to environment.

In the illustrated embodiment, the inspection tool 105 communicates with the external device 107. The external device 107 may include, for example, a smart telephone, a tablet computer, a cellular phone, a laptop computer, a smart watch, and so forth. The inspection tool 105 communicates with the external device 107, for example, to transmit at least a portion of the environment data for the inspection tool 105, to receive configuration information for the inspection tool 105, or a combination thereof. In some embodiments, the external device may include a short-range transceiver to communicate with the inspection tool 105, and a long-range transceiver to communicate with the server 110. In the illustrated embodiment, the inspection tool 105 also includes a transceiver to communicate with the external device via, for example, a short-range communication protocol such as BLUETOOTH®. In some embodiments, the external device 107 bridges the communication between the inspection tool 105 and the server 110. That is, the inspection tool 105 transmits environment data to the external device 107, and the external device 107 forwards the environment data from the inspection tool 105 to the server 110 over the network 115. The network 115 may be a long-range wireless network such as the Internet, a local area network (LAN), a wide area network (WAN), or a combination thereof. In other embodiments, the network 115 may be a short-range wireless communication network, and in yet other embodiments, the network 115 may be a wired network using, for example, USB cables. Similarly, the server 110 may transmit information to the external device 107 to be forwarded to the inspection tool 105. In some embodiments, the inspection tool 105 is equipped with a long-range transceiver instead of or in addition to the short-range transceiver. In such embodiments, the inspection tool 105 communicates directly with the server 110. In some embodiments, the inspection tool 105 may communicate directly with both the server 110 and the external device 107. In such embodiments, the external device 107 may, for example, generate a graphical user interface to facilitate control and programming of the inspection tool 105, while the server 110 may store and analyze larger amounts of environment data for future programming or operation of the inspection tool 105. In other embodiments, however, the inspection tool 105 may communicate directly with the server 110 without utilizing a short-range communication protocol with the external device 107.

The server 110 includes a server electronic control assembly having a server electronic processor 425, a server memory 430, a transceiver, and a machine learning classifier 120. The transceiver allows the server 110 to communicate with the inspection tool 105, the external device 107, or both. The server electronic processor 425 receives environment data from the inspection tool 105 (e.g., via the external device 107), stores the received tool environment data in the server memory 430, and, in some embodiments, uses the received tool environment data for building or adjusting a machine learning classifier 120.

The machine learning classifier 120 implements a machine learning program. The machine learning classifier 120 is configured to construct a model (e.g., building one or more algorithms) based on example inputs. Supervised learning involves presenting a computer program with example inputs and their actual outputs (e.g., categorizations). The machine learning classifier 120 is configured to learn a general rule or model that maps the inputs to the outputs based on the provided example input-output pairs. The machine learning algorithm may be configured to perform machine learning using various types of methods. For example, the machine learning classifier 120 may implement the machine learning program using decision tree learning, associates rule learning, artificial neural networks, recurrent artificial neural networks, long short term memory neural networks, inductive logic programming, support vector machines, clustering, Bayesian networks, reinforcement learning, representation learning, similarity and metric learning, sparse dictionary learning, genetic algorithms, k-nearest neighbor (KNN), among others, such as those listed in Table 1 below.

TABLE 1

| | |
|---|---|
| Recurrent | Recurrent Neural Networks [“RNNs”], Long Short-Term Memory |
| Models | [“LSTM”] models, Gated Recurrent Unit [“GRU”] models, Markov |
| | Processes, Reinforcement learning |
| Non-Recurrent | Deep Neural Network [“DNN”], Convolutional Neural Network [“CNN”], |
| Models | Support Vector Machines [“SVM”], Anomaly detection (ex: Principle |
| | Component Analysis [“PCA”]), logistic regression, decision trees/forests, |
| | ensemble methods (combining models), polynomial/Bayesian/other |
| | regressions, Stochastic Gradient Descent [“SGD”], Linear Discriminant |
| | Analysis [“LDA”], Quadratic Discriminant Analysis [“QDA”], Nearest |
| | neighbors classifications/regression, naïve Bayes, a random forest algorithm, |
| | a random forest algorithm, and so forth |

The machine learning classifier 120 is programmed and trained to perform a particular task. For example, in some embodiments, the machine learning classifier 120 is trained to label various objects or other aspects of the environment to which the inspection tool 105 deployed (e.g., within a pipe). The task for which the machine learning classifier 120 is trained may vary based on, for example, the type of inspection tool, a selection from a user, typical applications for which the inspection tool is used, and so forth. Analogously, the way in which the machine learning classifier 120 is trained also varies based on the particular task. In particular, the training examples used to train the machine learning classifier may include different information and may have different dimensions based on the task of the machine learning classifier 120. In the example mentioned above in which the machine learning classifier 120 is configured to identify aspects of a deployed to environment, each training example may include a set of inputs such as data collected from other similar environments (e.g., other pipes or tubes). Each training example also includes a specified output. For example, when the machine learning classifier 130 identifies a crack in a pipe, a training example may have an output that includes a particular label to associate with identified aspect, such as “crack.”. The training examples may be previously collected training examples, from for example, a plurality of the same type of inspection tools. For example, the training examples may have been previously collected from, for example, two hundred inspection tools of the same type (e.g., pipe inspection tools) over a span of, for example, one year.

A plurality of different training examples is provided to the machine learning classifier 120. The machine learning classifier 120 uses these training examples to generate a model (e.g., a rule, a set of equations, and so forth) that helps categorize or estimate the output based on new input data. The machine learning classifier 120 may weigh different training examples differently to, for example, prioritize different conditions or outputs from the machine learning classifier 120. For example, a training example corresponding to a crack in the pipe may be weighted more heavily than a training example corresponding to a curve or bend in the pipe's pathway to prioritize the correct identification of the crack relative to a curve the stripping condition. In some embodiments, the training examples are weighted differently by associating a different cost function or value to specific training examples or types of training examples.

In one example, the machine learning classifier 120 implements an artificial neural network. The artificial neural network typically includes an input layer, a plurality of hidden layers or nodes, and an output layer. Typically, the input layer includes as many nodes as inputs provided to the machine learning classifier 120. As described above, the number (and the type) of inputs provided to the machine learning classifier 120 may vary based on the particular task for the machine learning classifier 120. Accordingly, the input layer of the artificial neural network of the machine learning classifier 120 may have a different number of nodes based on the particular task for the machine learning classifier 120. The input layer connects to the hidden layers. The number of hidden layers varies and may depend on the particular task for the machine learning classifier 120. Additionally, each hidden layer may have a different number of nodes and may be connected to the next layer differently. For example, each node of the input layer may be connected to each node of the first hidden layer. The connection between each node of the input layer and each node of the first hidden layer may be assigned a weight parameter. Additionally, each node of the neural network may also be assigned a bias value. However, each node of the first hidden layer may not be connected to each node of the second hidden layer. That is, there may be some nodes of the first hidden layer that are not connected to all of the nodes of the second hidden layer. The connections between the nodes of the first hidden layers and the second hidden layers are each assigned different weight parameters. Each node of the hidden layer is associated with an activation function. The activation function defines how the hidden layer is to process the input received from the input layer or from a previous input layer. These activation functions may vary and be based on not only the type of task associated with the machine learning classifier 120 but may also vary based on the specific type of hidden layer implemented.

Each hidden layer may perform a different function. For example, some hidden layers can be convolutional hidden layers which can, in some instances, reduce the dimensionality of the inputs, while other hidden layers can perform more statistical functions such as max pooling, which may reduce a group of inputs to the maximum value, an averaging layer, among others. In some of the hidden layers (also referred to as “dense layers”), each node is connected to each node of the next hidden layer. Some neural networks including more than, for example, three hidden layers may be considered DNNs. The last hidden layer is connected to the output layer. Similar to the input layer, the output layer typically has the same number of nodes as the possible outputs. In the example above in which the machine learning classifier 120 identifies an object or aspect of the deployed to environment, the output layer may include, for example, four nodes. A first node may indicate a crack in the pipe, a second node may indicate a bend or curve in the pipe, a third node may indicate a junction with another pipe, and the fourth node may indicate that an unknown (or unidentifiable) object. In some embodiments, the machine learning classifier 120 then selects the output node with the highest value and indicates to the inspection tool 105 or to the user the corresponding label. In some embodiments, the machine learning classifier 120 may also select more than one output node. The machine learning classifier 120 or the electronic processor 550 may then use the multiple outputs to control the inspection tool 500. For example, the machine learning classifier 120 may identify a crack in the pipe and determine the label “crack” should be applied. The machine learning classifier 120 or the electronic processor 550 may then, for example, provide the label to the external device 107 or inspection tool 105. The machine learning classifier 120 and the electronic processor 550 may implement different methods of combining the outputs from the machine learning classifier 120.

During training, the artificial neural network receives the inputs for a training example and generates an output using the bias for each node, and the connections between each node and the corresponding weights. The artificial neural network then compares the generated output with the actual output of the training example. Based on the generated output and the actual output of the training example, the neural network changes the weights associated with each node connection. In some embodiments, the neural network also changes the weights associated with each node during training. The training continues until a training condition is met. The training condition may correspond to, for example, a predetermined number of training examples being used, a minimum accuracy threshold being reached during training and validation, a predetermined number of validation iterations being completed, and so forth. Different types of training algorithms can be used to adjust the bias values and the weights of the node connections based on the training examples. The training algorithms may include, for example, gradient descent, newton's method, conjugate gradient, quasi newton, levenberg marquardt, among others, see again Table 1.

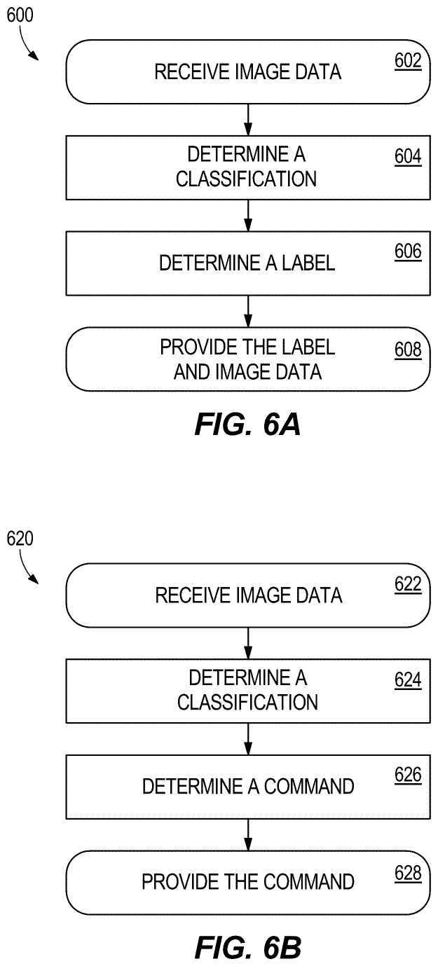

In another example, the machine learning classifier 120 may be implemented through a more traditional computer vision algorithm such as Scale-Invariant Feature Transform (SIFT), SURF, Oriented Features from Accelerated Segment Test (FAST) and Rotated Binary Robust Independent Elementary Features (BRIEF)(ORB) and so forth. In another example, the machine learning classifier 120 may take the form of a transformer or attention-based network. In another example, the machine learning classifier 120 may include a binary decision (e.g., a crack present), a decision among multiple labels (e.g., what best describes a region of the environment), a multiple classification problem (identify all of the correct characteristics of the environment), or a visual classification problem (identify the pixels or identify appropriate boundaries associated with a characteristic of the environment) (See. FIG. 6A).

In another example, the machine learning classifier 120 may determine visual classifications based on the distribution of colors or brightness of the images. For example, a histogram or other summary means of the pixel colors, shades, or saturations into a logical block (e.g., crude logic, DNN, random forest, decision tree, KNN, logistic regression, and so forth) may be used to classify an aspect of the environment such as a crack in a pipe (See FIG. 6B).

In some embodiments, the machine learning classifier 120 classifies collected audio classifications via RNNs and attention networks. In some embodiments, the machine learning classifier 120 identifies if a “thing” or group of things in an image is of interest. In another example, the machine learning classifier 120 may identify various borders.

In some embodiments, input images may be reduced or down sampled and fewer than every frame may be analyzed. In some embodiments, the frequency of frames or samples and/or the resolution of such frames or samples analyzed may be modified based on, for example, 1) the speed of traversal (as depth can be determined based on information received from a rotary sensor), 2) recently seen objects of interest, and 3) device settings (e.g., setting determined by a user, company, group, administrator, and so forth).

In some embodiments, the at least one sensor may include a microphone, an inductive sensor, a capacitive sensor, a magnetometer, temperature sensors, humidity sensors, electrical contact sensors, motion sensors, and so forth along with a camera. In some embodiments, the machine learning classifier 120 may receive environment data from these sensors independently or with the images provide by the camera, which are processes to determine particular classifications and labels. For example, PCV may not show an inductive effect, the presence of water may trip electrical contact sensors to identify wetness or the sound of running water may help classify running water.

The training examples for a support vector machine include an input vector including values for the input variables and an output classification (e.g., a crack in the pipe). During training, the support vector machine selects the support vectors (e.g., a subset of the input vectors) that maximize the margin. In some embodiments, the support vector machine may be able to define a line or hyperplane that accurately separates cracks from other aspects. In other embodiments (e.g., in a non-separable case), however, the support vector machine may define a line or hyperplane that maximizes the margin and minimizes the slack variables, which measure the error in a classification of a support vector machine. After the support vector machine has been trained, new input data can be compared to the line or hyperplane to determine how to classify the new input data (e.g., to determine whether the pipe has a crack). In other embodiments, as mentioned above, the machine learning classifier 120 can implement different machine learning algorithms to make an estimation or classification based on a set of input data.

Some examples of input data, processing technique, and machine learning algorithm pairings are listed below in Table 2. The input data, listed as time series data in the below table, includes, for example, one or more of the various examples of time-series tool environment data described herein.

TABLE 2

| Input Data | Data Processing | Exemplary Model |
|---|---|---|
| Time Series Data | N/A | RNN (using LSTM) |
| Time Series Data | Filtering (e.g., low-pass | DNN classifier/regression |
| | filters) | or another non-recurrent |
| | | algorithm |
| Time Series Data | Sliding window, | DNN classifier/regression |
| | padding, or data subset | or another non-recurrent |
| | | algorithm |
| Time Series Data | Make features (e.g., | KNN or another non- |
| | summarize analysis of | recurrent or recurrent |
| | runtime data) | algorithm |
| Time Series Data | Initial (e.g., pre- | Model adaptation |
| | trained) model | |
| Time Series Data | Initial RNN or DNN | Markov Model |
| | analysis for | |
| | classification | |

In the example of FIG. 1, the server 110 receives environment data from the inspection tool 105. In some embodiments, the server 110 uses the received environment data as additional training examples (e.g., when the actual value or classification is also known). In other embodiments, the server 110 sends the received environment data to the trained machine learning classifier 120. The machine learning classifier 120 is then employed to classify various aspects of the environments and determine labels for these aspects based on the input environment data. For example, the trained machine learning classifier 120 may process the received image data to determine that a crack has formed in a pipe. The server 110 may then transmit a suggested label for the determined classification (e.g., “Crack”) to the external device 107. The external device 107 may prompt the user if they would like to include the label. The external device 107 may also prompt the user with additional options such as, for example, “Not a Crack,” “Something Else,” “Ignore,” “Unsure”, and so forth. Additionally, a user's selection of certain options (e.g., “Unsure) may trigger a prompt to send or sending the image or footage to another user or a network of users. Moreover, selecting an option (e.g., “Crack” or “Not a Crack”) may be used as a positive or negative example for feedback and (re)training of the algorithm. Alternatively, in some embodiments, a classification (especially if questionable) may not appear during inspection, but appear after an inspection takes place, such as when reviewing videos. In such examples, the trained machine learning classifier 120 would be provided additional time to analyze the received environment data. In some embodiments, the external device 107 provides an audio-based UI such that a user can verbally confirm, deny, adjust, add, or remove labels during operation.

In some embodiments, the external device 107 receives labels from the server 110 in real-time as the machine learning classifier 120 process the environment data received form the inspection tool 105. In some embodiments, the external device 107 automatically applies the received labels to the collected data (e.g., video), which is displayed via a user interface. In some embodiments, the applied labels are stored as metadata associated with the corresponding collected data (e.g., within the video). In some embodiments, the metadata is stored in one or multiple files. In some embodiments, the metadata is stored separately from the corresponding collected data. In some embodiments, for video data, labels may be associated with each frame or sample, each nth frame, a group of preferably consecutive frames (e.g., 10 frames in a row), a timestamp associated with one or more frames, or a timestamp associated with a real time of data collected or when labelled.

In some embodiments, when the external device 107 is provided a label from the server 110 (e.g., an aspect of the environment has been identified) the external device 107 provides and alert (e.g., audio, haptic, or visual) to the user. For example, a visual alert could include a screen flash, a border highlighted on a display, a pop-up classification, a border around an object in the video or image, and so forth.

In some embodiments, when the external device 107 may provide instructions to the inspection tool 105 based on the received labels. For example, the external device 107 may instruct the inspection tool 105 to slow down the feed rate so as to allow the user to have more time to view the feed. As another example when a particular thing of interest is identified, the external device 107 may instruct the inspection tool 105 to zoom, pan, rotate, switch (if multiple cameras), change coloring, lighting (e.g., adjust brightness), and so forth, to help view or bright attention to the thing of interest. In some embodiments, the external device 107 may provide instructions to the inspection tool 105 to employ a brake on a drum such that a user is forced to pause.

In some embodiments, the external device 107 may provide options the user on a display to assist the users in selecting a direction or to navigate the device. In some embodiments, a user may input a desired path and the external device 107 instructs the inspection device 105 in an attempt to successful navigate the path (e.g., particular trying and retracting and retrying). In some embodiments, Detection as to whether the right path achieved the external device 107 and/or the inspection device 105 may employ stop, look, assess, manage (SLAM) techniques, motion sensors (e.g., an accelerometer, gyroscope, and so forth) to identify and track visual features of the interior of the environments (e.g., the pipe).

As another example, when a particular object of interest is identified, the external device 107 augments (e.g., highlight; add a border, provide a zoom effect) the visualization of the object on the display. In some embodiments, the augmentation is saved as part of the video. In some embodiments, the augmentation is not saved as part of the video so as to preserve the original image. In some embodiments, the augmentation may be stored separately and retrieved for later viewing of the video (e.g., saved as another layer, in metadata, or to a separate file).

In some embodiments, various parameters of the collected data may be altered as the data is displayed as the external device 107 receives labels from the server 110. For example, the external device 107 may alter (or provided instruction to the inspection device 105 to alter) lighting, digital contrast, digital resolution, digital brightness, color mapping, the frame rate (e.g., to allow for higher quality or clearer images) and so forth, based on the received labels.

In some embodiments, the external device 107 may perform actions based on the received labels. For example, a region or portion of video, images, or sound (whether in time or frame to frame or particular part of a frame) with higher resolution or less compression, may be saved based on a label indicating the detection of an object. As another example, forwarding speed may be reduced and forward progression may be paused or stopped.

In some embodiments, the external device 107 may augment video in real-time via localization algorithms, such as YOLO, Mask R-CNN, R-CNN, Faster R-CNN, and so forth. Such an augmentation can be a box, mask, or outline. In some embodiments, by employing computer vision, measurements of various identified aspects and objects (e.g., cracks, defects, roots, and so forth) can be determined. In some embodiments, the external device 107 combines global positioning system (GPS) data, information received from an inertial measurement unit, and the distance from the reel to use Kalman filters to determine the location and position of the camera head. In some embodiments, the GPS could be on the control hub or the camera head. In some embodiments, the inertial measurement unit could be on the camera head.

In some embodiments, the determined labels may be associated with a depth (extension) of the sensor or the location of the classification. In some embodiments, the location of the classification may be based on dead reckoning in which an extension of the sensor (e.g., an accelerometer, gyroscope, magnetometer, and so forth) is known from a rotary drum and the sensor module provides directional input. In some embodiments, the sensor passively self-levels using a weight to ensure that it is level to a plane (e.g., the horizon). In some embodiments, a sensor detects the rotation associated with the self-leveling scheme is employed to collect information about when, for example, the pipe turns or when the user turns the cable. In some embodiments, data regarding these motions is provided to the machine learning classifier 120 to provide further inform about the position of the sensor. In some embodiments, a location of a classification determined by the machine learning classifier 120 may be based on a positional, detection device (e.g., a sonde). For example, the sonde's signal strength may be diminished when the pipe is moving through an area of ground below the water table versus dry sand.

In some embodiments, the determined labels are association with project data, such as a jobsite or date and time of an inspection. For example, the determined label may be used to tag a jobsite as “this jobsite had two cracks identified and the pipe was PVC.” In some embodiments, the determined labels are associated with a particular region of a particular frame or frames. For instance, cracks are present on both sides of a pipe.

In some embodiments, the external device 107 may stitch the images collected by the inspection tool 105 via the sensor 102 together with, for example, dead reckoning. In such embodiments, an extension sensor (e.g., a pipeline drum) may be used for one-dimensional (1D) motion. In some embodiments, the sensor 102 is self-leveling and orients the sensor 102 to the bottom of the pipe. In such embodiments to simplifies the stitching, a nominal potentially constant pipe diameter may be assumed, a pipe may be assumed substantially straight except at joints, or a pipe may be displayed as fully straight with the only factor being a 1D travel path through the pipe. In some embodiments, the stitching is performed with a SLAM technique (e.g., light detection and ranging (LIDAR), image synthesis, sensor fusion with motion or depth sensing). In some embodiments, a consistent lighting or other visual aspect is selected for the stitching to improve the overall view of the object of interest.

In some embodiments, the stitching may produce a three-dimensional (3D) snake-like representation of a pipe or tube where the pipe diameter may be assumed a nominal size so that image pixels cab be mapped onto a tube-like structure and the 3D representation may not map to the tube so that 3D physical objects (e.g., roots) may be represented. In some embodiments, the stitching may produce a 3D non-snake like representation of an entire system (e.g., behind a wall). In some embodiments, the stitching may produce a two-dimensional (2D), constant diameter pipe or tube such that the pipe or tube may be “unrolled” to a 1D image that account for, for example, joints where the pipe or tube runs in multiple directions. In some embodiments, this 1D image may looks something like a ‘tree’ once unrolled.

In some embodiments, images are stitched together based on positioning and a video or loop like animation is provided of the stitched images showing, for example, time lapse (e.g., via an animation showing running water or for ‘stitching’ together images that may appear differently due to lighting). In some embodiments, such an animation can be used show an early image of pipe segment of pipe which animates to a later image of the pipe.

In some embodiments, 3D, 2D, or 1D stitching process may employed to provide estimates of distance and space to accurately produce the shape of the pipe or tube. In some embodiments, labels may be associate with various aspects of the pipe or tube. For example, labels may be spatially placed along the pipe; provided via bounding, boxes, or boarders; represented via callouts; used to augment the stitching by highlighting or desaturating less interesting parts of the pipe or tube. In some embodiments, the stitching may crop or compressed the pipe or tube to focus only of regions of interest.

In some embodiments, the trained machine learning classifier 120 may be improved over time with new examples, different classifications (e.g., new labels), improved model structures. In particular, in the embodiment illustrated in FIG. 1, the server electronic control assembly employs a distributed learning technique to merge the trainings received from multiple users. For example, feedback provided by certain users, especially those considered more skilled, is weighted more heavily. In some embodiments, the server electronic control assembly employs historical prevalence of particular classifications (e.g., this user typically sees cracks, but not roots) as a factor in the training of the trained machine learning classifier 120.

In some embodiments, a variation of the sensor's 102 detection wavelength or through sonar imaging may seeing through allow non-metallic pipes (such as far IR imaging). This would assist in allowing detection of impending problems (such as a nearby root that is about to break the pipe) in addition to existing problems. In some embodiments, the inspection tool 105 broadcasts audio signals into a pipe to measured sounds, which is provided within the environment data for processing by the machine learning classifier 120. In some embodiments, the sensor 102 includes electrodes to energize the environment and assist in detecting the location of the environment (e.g., with a sonde where an energized pipe acts as an antenna). In some embodiments, the energization process itself could assist the machine learning classifier 120 in diagnosing problems by, for example, measuring the resistance of the connection to detect cracks or breaks and complement the visual techniques described herein.

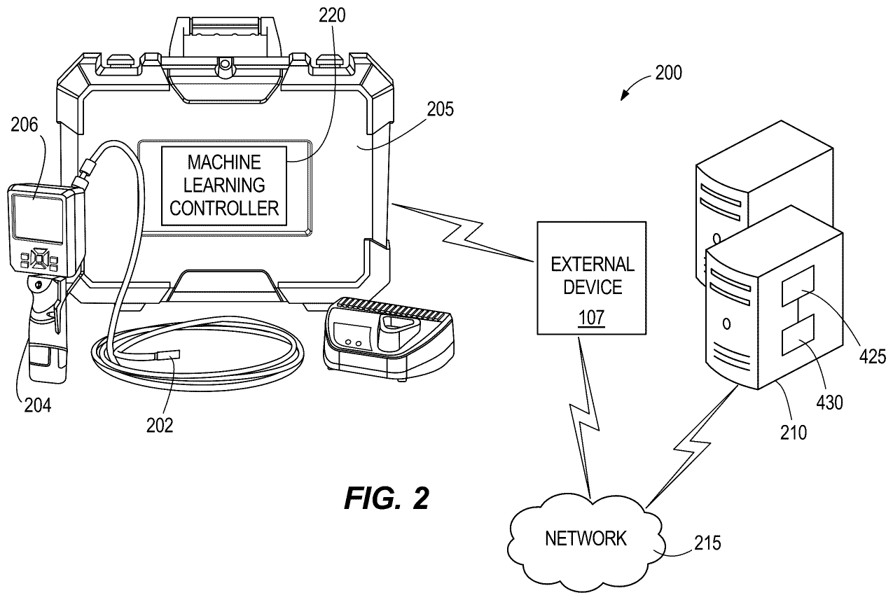

FIG. 2 illustrates a second inspection tool system 200. The second inspection tool system 200 includes an inspection tool 205 having at least one sensor 202, a housing 204, a display or user interface 206, the external device 107, a server 210, and a network 215. The inspection tool 205 is similar to that of the inspection tool system 100 of FIG. 1 and collects similar environment data as that described with respect to FIG. 1. Unlike the inspection tool 105 of the first inspection tool system 100, the inspection tool 205 of the second inspection tool system 200 includes a static machine learning classifier 220. In the illustrated embodiment, the inspection tool 205 receives the static machine learning classifier 220 from the server 210 over the network 215. In some embodiments, the inspection tool 205 receives the static machine learning classifier 220 during manufacturing, while in other embodiments, a user of the inspection tool 205 may select to receive the static machine learning classifier 220 after the inspection tool 205 has been manufactured and, in some embodiments, after operation of the inspection tool 205. The static machine learning classifier 220 is a trained machine learning classifier similar to the trained machine learning classifier 120 in which the machine learning classifier 120 has been trained using various training examples and is configured to receive new input data and generate an estimation or classification for the new input data.

The inspection tool 205 communicates with the server 210 via, for example, the external device 107 as described above with respect to FIG. 1. The external device 107 may also provide additional functionality (e.g., generating a graphical user interface) to the inspection tool 205. The server 210 of the inspection tool system 200 may employ environment data from inspection tools similar to the inspection tool 205 (for example, when the inspection tool 205 is a pipe inspection tool, the server 210 may receive environment data from various other pipe inspection tools) and trains a machine learning program using training examples from the received environment data from the inspection tools. The server 210 then transmits the trained machine learning program to the machine learning classifier 220 of the inspection tool 205 for execution during future operations of the inspection tool 205.

Accordingly, the static machine learning classifier 220 includes a trained machine learning program provided, for example, at the time of manufacture. During future operations of the inspection tool 205, the static machine learning classifier 220 analyzes new environment data from the inspection tool 205 and generates recommendations or actions based on the new environment data. As discussed above with respect to the machine learning classifier 120, the static machine learning classifier 220 has one or more specific tasks such as, for example, determining a label for aspects of the deployed to environment of the inspection tool 205. In other embodiments, the task of the static machine learning classifier 220 may be different. In some embodiments, a user of the inspection tool 205 may select a label for the static machine learning classifier 220 using, for example, a graphical user interface generated by the external device 107. The external device 107 may then transmit the label for the static machine learning classifier 220 to the server 210. The server 210 then transmits a trained machine learning program, trained for the label determination, to the static machine learning classifier 220. Based on the estimations or classifications from the static machine learning classifier 220, the inspection tool 205 may provide labels for the collected environment data (e.g., via a video display). In some embodiments, the inspection tool 205 may include more than one static machine learning classifier 220, each having different label determinations.

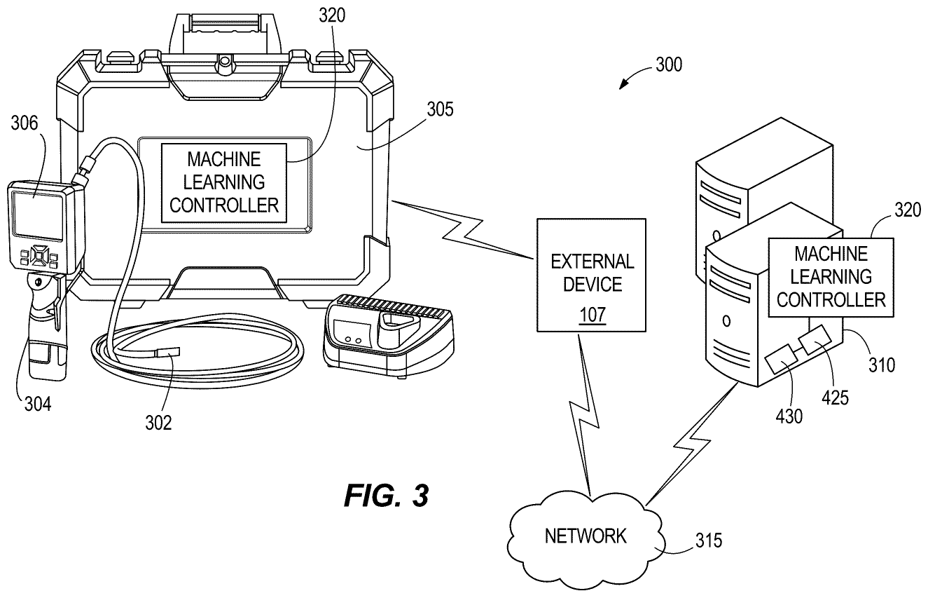

FIG. 3 illustrates a third inspection tool system 300. The third inspection tool system 300 also includes an inspection tool 305 having at least one sensor 302, a housing 304, a display or user interface 306, an external device 107, a server 310, and a network 315. The inspection tool 305 is similar to the inspection tools 105, 205 described above and includes similar sensors that monitor various types of environment data of the inspection tool 305. The inspection tool 305 of the third inspection tool system 300, however, includes an adjustable machine learning classifier 320 instead of the static machine learning classifier 220 of the second inspection tool 205. In the illustrated embodiment, the adjustable machine learning classifier 320 of the inspection tool 305 receives the machine learning program from the server 310 over the network 315. Unlike the static machine learning classifier 220 of the second inspection tool 205, the server 310 may transmit updated versions of the machine learning program to the adjustable machine learning classifier 320 to replace previous versions.

The inspection tool 305 of the third inspection tool system 300 transmits feedback to the server 310 (via, for example, the external device 107) regarding the deployed to environment of the adjustable machine learning classifier 320. The inspection tool 305, for example, may transmit an indication to the server 310 regarding the number of aspects or objects that were incorrectly classified by the adjustable machine learning classifier 320. The server 310 receives the feedback from the inspection tool 305, updates the machine learning program, and provides the updated program to the adjustable machine learning classifier 320 to reduce the number of aspects or objects that are incorrectly classified. Thus, the server 310 updates or re-trains the adjustable machine learning classifier 320 in view of the feedback received from the inspection tool 305. In some embodiments, the server 310 also uses feedback received from similar inspection tools to adjust the adjustable machine learning classifier 320. In some embodiments, the server 310 updates the adjustable machine learning classifier 320 periodically (e.g., every month). In other embodiments, the server 310 updates the adjustable machine learning classifier 320 when the server 310 receives a predetermined number of feedback indications (e.g., after the server 310 receives two feedback indications). The feedback indications may be positive (e.g., indicating that the adjustable machine learning classifier 320 correctly classified an aspect or object), or the feedback may be negative (e.g., indicating that the adjustable machine learning classifier 320 incorrectly classified an aspect or object).

In some embodiments, the server 310 also employ new environment data received from the inspection tool 305 and other similar inspection tools to update the adjustable machine learning classifier 320. For example, the server 310 may periodically re-train (or adjust the training) of the adjustable machine learning classifier 320 based on the newly received environment data. The server 310 then transmits an updated version of the adjustable machine learning classifier 320 to the inspection tool 305.

In some embodiments, when the inspection tool 305 receives the updated version of the adjustable machine learning classifier 320 (e.g., when an updated machine learning program is provided to and stored on the machine learning classifier 320), the inspection tool 305 replaces the current version of the adjustable machine learning classifier 320 with the updated version. In some embodiments, the inspection tool 305 is equipped with a first version of the adjustable machine learning classifier 320 during manufacturing. In such embodiments, the user of the inspection tool 305 may request newer versions of the adjustable machine learning classifier 320. In some embodiments, the user may select a frequency with which the adjustable machine learning classifier 320 is transmitted to the inspection tool 305.

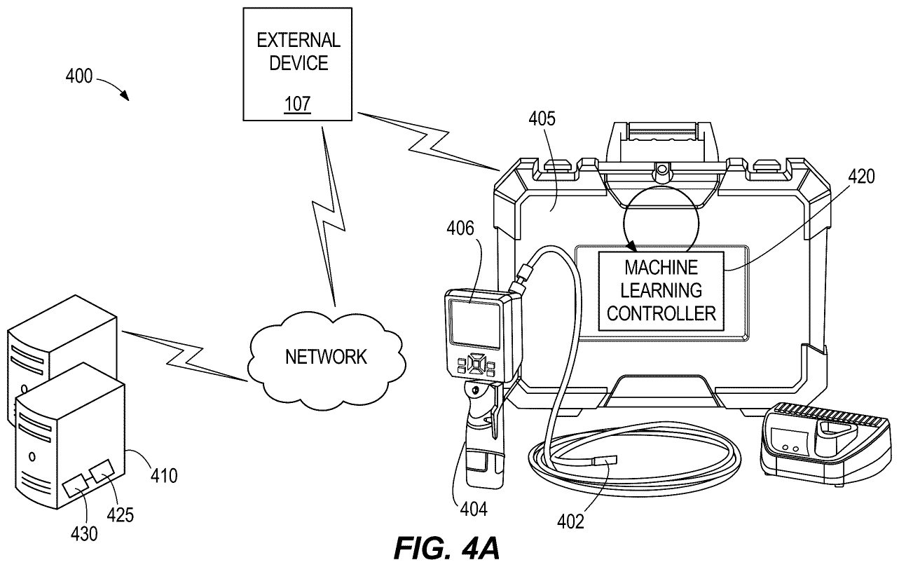

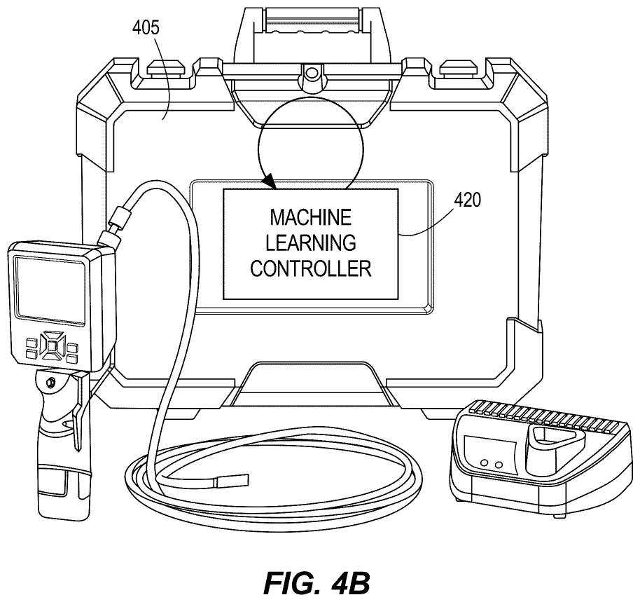

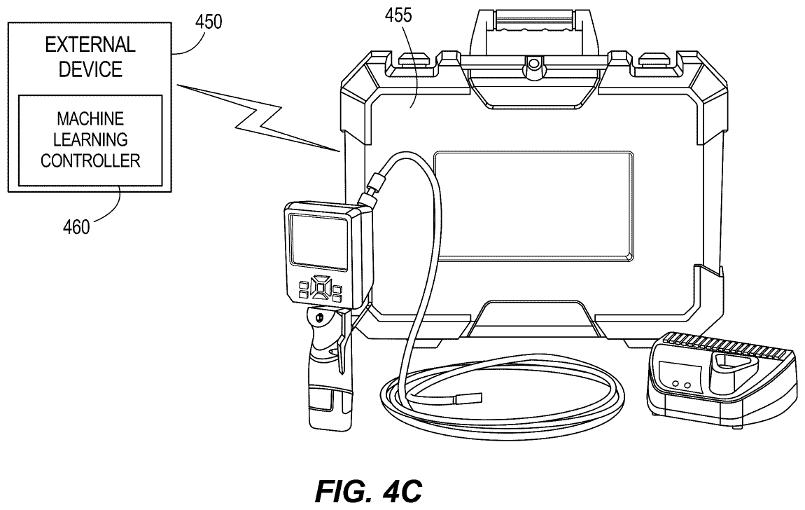

FIG. 4A illustrates a fourth inspection tool system 400. The fourth inspection tool system 400 includes an inspection tool 405 having at least one sensor 402, a housing 404, a display or user interface 406, an external device 107, a network 415, and a server 410. The inspection tool 405 includes a self-updating machine learning classifier 420. The self-updating machine learning classifier 420 is first loaded on the inspection tool 405 during, for example, manufacturing. The self-updating machine learning classifier 420 updates itself. In other words, the self-updating machine learning classifier 420 receives new environment data from the sensors 102 in the inspection tool 405 and feedback information received from a user (e.g., whether the labels determined by the machine learning classifier 420 were correct). The self-updating machine learning classifier 420 then uses the received information to re-train the self-updating machine learning classifier 420.

In some embodiments, the inspection tool 405 re-trains the self-updating machine learning classifier 420 when the inspection tool 405 is not in operation. For example, the inspection tool 405 may detect when the inspection tool 402 has not been operated for a predetermined time period and start a re-training process of the self-updating machine learning classifier 420 while the inspection tool 405 remains non-operational. Training the self-updating machine learning classifier 420 while the inspection tool 405 is not operating allows more processing power to be used in the re-training process instead of competing for computing resources typically used to operate the inspection tool 405.

In some embodiments, the self-updating machine learning classifier 420 may be updated in a tool via a bootloader (e.g., a flash drive). In some embodiments, the self-updating machine learning classifier 420 includes a single algorithm, multiple algorithms, or the entire firmware/software of the tool.

As shown in FIG. 4A, in some embodiments, the inspection tool 405 also communicates with the external device 107 and a server 410. For example, the external device 107 communicates with the inspection tool 405 as described above with respect to FIGS. 1-3. The external device 107 generates a graphical user interface to facilitate the adjustment of operational parameters of the inspection tool 405. The external device 107 may also bridge the communication between the inspection tool 405 and the server 410. For example, as described above with respect to FIG. 2, in some embodiments, the external device 107 receives a selection of a label from the machine learning classifier 420. The external device 107 may then request a corresponding machine learning program from the server 410 for transmitting to the inspection tool 405. The inspection tool 405 also communicates with the server 410 (e.g., via the external device 107). In some embodiments, the server 410 may also re-train the self-updating machine learning classifier 420, for example, as described above with respect to FIG. 3. The server 410 may use additional training examples from other similar inspection tools. Using these additional training examples may provide greater variability and ultimately make the machine learning classifier 420 more reliable. In some embodiments, the inspection tool 405 re-trains the self-updating machine learning classifier 420 when the inspection tool 405 is not in operation, and the server 410 may re-train the machine learning classifier 420 when the inspection tool 405 remains in operation (for example, while the inspection tool 405 is in operation during a scheduled re-training of the machine learning classifier 420). Accordingly, in some embodiments, the self-updating machine learning classifier 420 may be re-trained on the inspection tool 405, by the server 410, or with a combination thereof. In some embodiments, the server 410 does not re-train the self-updating machine learning classifier 420, but still exchanges information with the inspection tool 405. For example, the server 410 may provide other functionality for the inspection tool 405 such as, for example, transmitting information regarding various operating modes for the inspection tool 405. In some embodiments, the self-updating machine learning classifier 420 employs reinforcement learning from classifications by the user and/or confirmations/rejections by the user to locally train allowing new classification labels unique to a particular user.

Each of FIGS. 1-4A describes an inspection tool system 100, 200, 300, 400 in which an inspection tool 105, 205, 305, 405 communicates with a server 110, 210, 310, 410 and with an external device 107. As discussed above with respect to FIG. 1, the external device 107 may bridge communication between the inspection tool 105, 205, 305, 405 and the server 110, 210, 310, 410. That is, the inspection tool 105, 205, 305, 405 may communicate directly with the external device 107. The external device 107 may then forward the information received from the inspection tool 105, 205, 305, 405 to the server 110, 210, 310, 410. Similarly, the server 110, 210, 310, 410 may transmit information to the external device 107 to be forwarded to the inspection tool 105, 205, 305, 405. In such embodiments, the inspection tool 105, 205, 305, 405 may include a transceiver to communicate with the external device 107 via, for example, a short-range communication protocol such as BLUETOOTH®. The external device 107 may include a short-range transceiver to communicate with the inspection tool 105, 205, 305, 405, and may also include a long-range transceiver to communicate with the server 110, 210, 310, 410. In some embodiments, a wired connection (via, for example, a USB cable) is provided between the external device 107 and the inspection tool 105, 205, 405 to enable direct communication between the external device 107 and the inspection tool 105, 205, 305, 405. Providing the wired connection may provide a faster and more reliable communication method between the external device 107 and the inspection tool 105, 205, 305, 405.

The external device 107 may include, for example, a smart telephone, a tablet computer, a cellular phone, a laptop computer, a smart watch, and so forth. The server 110, 210, 310, 410 illustrated in FIGS. 1-4A includes at least a server electronic processor 425, a server memory 430, and a transceiver to communicate with the inspection tool 105, 205, 305, 405 via the network 115, 215, 315, 415. The server electronic processor 425 receives tool environment data from the inspection tool 105, 205, 305, 405, stores the tool environment data in the server memory 430, and, in some embodiments, uses the received tool environment data for building or adjusting the machine learning classifier 120, 220, 320, 420. The term external system device may be used herein to refer to one or more of the external devices 107 and the server 110, 210, 310, and 410, as each are external to the inspection tool 105, 205, 305, 405. Further, in some embodiments, the external system device is a wireless hub, such as a beaconing device place on a jobsite to monitor tools, function as a gateway network device (e.g., providing Wi-Fi network), or both. As described herein, the external system device includes at least an input/output unit (e.g., a wireless or wired transceiver) for communication, a memory storing instructions, and an electronic processor to execute instructions stored on the memory to carry out the functionality attributed to the external system device.

In some embodiments, the inspection tool 405 may not communicate with the external device 107 or the server 410. For example, FIG. 4B illustrates the inspection tool 405 with no connection to the external device 107 or the server 410. Rather, since the inspection tool 405 includes the self-updating machine learning classifier 420, the inspection tool 405 can implement the machine learning classifier 420, receive user feedback, and update the machine learning classifier 420 without communicating with the external device 107 or the server 410.

FIG. 4C illustrates a fifth inspection tool system 450 including an inspection tool 455 and the external device 107. The external device 107 communicates with the inspection tool 455 using the various methods described above with respect to FIGS. 1-4A. In particular, the inspection tool 455 transmits environment data regarding the deployed to environment of the inspection tool 455 to the external device 107. The external device 107 generates a graphical user interface to facilitate the identification and labeling of aspects of the deployed to environment of the inspection tool 455. In the illustrated embodiment of FIG. 4C, the external device 107 includes a machine learning classifier 460. In some embodiments, the machine learning classifier 460 is similar to the machine learning classifier 120 of FIG. 1. In such embodiments, the machine learning classifier 460 receives the environment data from the inspection tool 455 and classifies aspects of the deployed to environment and determined labels for these aspects. The external device 107 then transmits the labels to the inspection tool 455 to be displayed along with the collected data to a user (e.g., as a video).

In some embodiments, the machine learning classifier 460 is similar to the machine learning classifier 320 of FIG. 3. In such embodiments, the external device 107 may update the machine learning classifier 460 based on, for example, feedback received from the inspection tool 455 and/or other environment data from the inspection tool 455. In such embodiments, the inspection tool 455 also includes a machine learning classifier similar to, for example, the adjustable machine learning classifier 320 of FIG. 3. The external device 107 can then modify and update the adjustable machine learning classifier 320 and communicate the updates to the machine learning classifier 320 to the inspection tool 455 for implementation. For example, the external device 107 can use the feedback from the user (e.g., selection of a label) to retrain the machine learning classifier 460, to continue training a machine learning classifier 460 implementing a reinforcement learning control, or may, in some embodiments, use the feedback to adjust a switching rate on a recurrent neural network for example.

In some embodiments, as discussed briefly above, the inspection tool 455 also includes a machine learning classifier. The machine learning classifier of the inspection tool 455 may be similar to, for example, the static machine learning classifier 220 of FIG. 2, the adjustable machine learning classifier 320 of FIG. 3 as described above, or the self-updating machine learning classifier 420 of FIG. 4A.

FIGS. 1-4C illustrate example inspection tools in the form of a pipe inspection tool 105, 205, 305, 405. The particular inspection tools 105, 205, 305, 405 illustrated and described herein, however, are merely representative. In other embodiments, the inspection tool systems 100, 200, 300, 400 described herein may include different types of inspection tools such as described above.

Each of FIGS. 1-4C illustrate various embodiments in which different types of machine learning classifiers 120, 220, 320, 420 are used in conjunction with the inspection tool 105, 205, 305, 405. In some embodiments, each inspection tool 105, 205, 305, 405 may include more than one machine learning classifier 120, 220, 320, 420, and each machine learning classifier 120, 220, 320, 420 may be of a different type. For example, an inspection tool 105, 205, 305, 405 may include a static machine learning classifier 220 as described with respect to FIG. 2 and may also include a self-updating machine learning classifier 420 as described with respect to FIG. 4A. In another example, the inspection tool 105, 205, 305, 405 may include a static machine learning classifier 220. The static machine learning classifier 220 may be subsequently removed and replaced by, for example, an adjustable machine learning classifier 320. In other words, the same inspection tool may include any of the machine learning classifiers 120, 220, 320, 420 described above with respect to FIGS. 1-4C. Additionally, a machine learning classifier 540, shown in FIG. 6 and described in further detail below, is an example controller that may be used as one or more of the machine learning classifiers 120, 220, 320, 420, and 460.

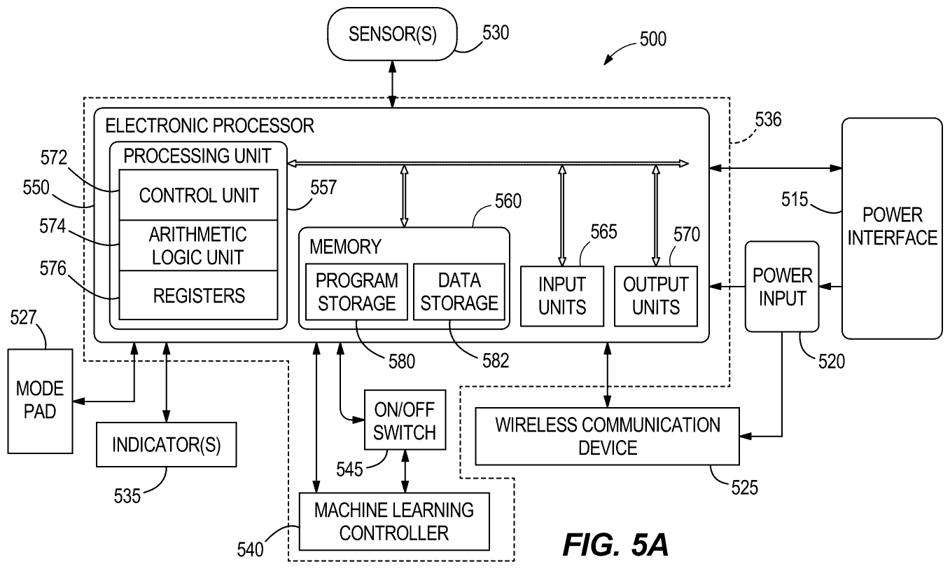

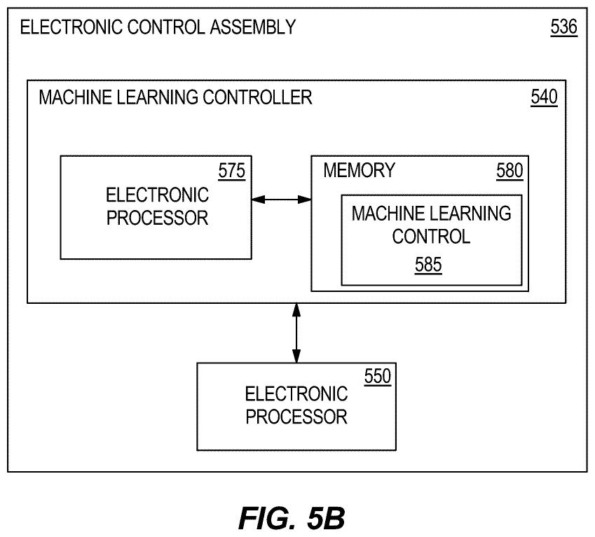

FIG. 5A is a block diagram of a representative inspection tool 500 in the form of a pipe inspection tool and including a machine learning classifier. Similar to the example inspection tools of FIGS. 1-4C, the inspection tool 500 is representative of various types of inspection tools. Accordingly, the description with respect to the inspection tool 500 is similarly applicable to other types of inspection tools. The machine learning classifier of the inspection tool 500 may be a static machine learning classifier similar to the static machine learning classifier 220 of the second inspection tool 205, an adjustable machine learning classifier similar to the adjustable machine learning classifier 320 of the third inspection tool 305, or a self-updating machine learning classifier similar to the self-updating machine learning classifier 420 of the fourth inspection tool 405. Although the inspection tool 500 of FIG. 5A is described as being in communication with the external device 107 or with a server, in some embodiments, the inspection tool 500 is self-contained or closed, in terms of machine learning, and does not need to communicate with the external device 107 or the server to perform the functionality of the machine learning classifier 540 described in more detail below.

As shown in FIG. 5A, the inspection tool 500 includes a power interface 515, a switching network 517, a power input control 520, a wireless communication device 525, a mode pad 527, a plurality of sensors 530, a plurality of indicators 535, and an electronic control assembly 536. The electronic control assembly 536 includes a machine learning classifier 540, an activation switch 545, and an electronic processor 550. In some embodiments, the external power source includes an AC power source. In such embodiments, the power interface 515 includes an AC power cord that is connectable to, for example, an AC outlet. In other embodiments, the external power source includes a battery pack. In such embodiments, the power interface 515 includes a battery pack interface. The battery pack interface may include a battery pack receiving portion on the inspection tool 500 that is configured to receive and couple to a battery pack. The battery pack receiving portion may include a connecting structure to engage a mechanism that secures the battery pack and a terminal block to electrically connect the battery pack to the inspection tool 500.

The sensors 530 are coupled to the electronic processor 550 and communicate to the electronic processor 550 various output signals. The sensors 530 include various devices, such as described in detail above regarding sensors 102, 202, 302, and 402, to collect information (e.g., image data) regarding an environment in which the inspection tool 500 has been deployed.

The indicators 535 are also coupled to the electronic processor 550. The indicators 535 receive control signals from the electronic processor 500 to generate a visual signal to convey information regarding the operation or state of the inspection tool 500 to the user. The indicators 535 may include, for example, LEDs or a display screen and may generate various signals indicative of, for example, an operational state or mode of the inspection tool 500, an abnormal condition or event detected during the operation of the inspection tool 500, and so forth. In some embodiments, the indicators 535 include elements to convey information to a user through audible or tactile outputs. In some embodiments, the inspection tool 500 does not include the indicators 535.

The power interface 515 is coupled to the power input control 520. The power interface 515 transmits the power received from the external power source to the power input control 520. The power input control 520 includes active and/or passive components (e.g., voltage step-down controllers, voltage converters, rectifiers, filters, and so forth) to regulate or control the power received through the power interface 515 to the electronic processor 550 and other components of the inspection tool 500 such as the wireless communication device 525.

The wireless communication device 525 is coupled to the electronic processor 550. In the example inspection tools 105, 205, 305, 405 of FIGS. 1-4A and 4C, the wireless communication device 525 is located near the foot of the inspection tool 105, 205, 305, 405 (see FIGS. 1-4C) to save space. In a particular example, the wireless communication device 525 is positioned under the mode pad 527. The wireless communication device 525 may include, for example, a radio transceiver and antenna, a memory, a processor, and a real-time clock. The radio transceiver and antenna operate together to send and receive wireless messages to and from the external device 107, a second inspection tool 500, or the server 110, 210, 310, 410 and the processor. The memory of the wireless communication device 525 stores instructions to be implemented by the processor and/or may store data related to communications between the inspection tool 500 and the external device 107, a second inspection tool 500, or the server 110, 210, 310, 410. The processor for the wireless communication device 525 controls wireless communications between the inspection tool 500 and the external device 107, a second inspection tool 500, or the server 110, 210, 310, 410. For example, the processor of the wireless communication device 525 buffers incoming and/or outgoing data, communicates with the electronic processor 550, and determines the communication protocol and/or settings to use in wireless communications.

In some embodiments, the wireless communication device 525 is a Bluetooth® controller. The Bluetooth® controller communicates with the external device 107, a second inspection tool 500, or server 110, 210, 310, 410 employing the Bluetooth® protocol. In such embodiments, therefore, the external device 107, a second inspection tool 500, or server 110, 210, 310, 410 and the inspection tool 500 are within a communication range (i.e., in proximity) of each other while they exchange data. In other embodiments, the wireless communication device 525 communicates using other protocols (e.g., Wi-Fi, cellular protocols, a proprietary protocol, and so forth) over a different type of wireless network. For example, the wireless communication device 525 may be configured to communicate via Wi-Fi through a wide area network such as the Internet or a local area network, or to communicate through a piconet (e.g., using infrared or NFC communications). The communication via the wireless communication device 525 may be encrypted to protect the data exchanged between the inspection tool 500 and the external device 107, a second inspection tool 500, or server 110, 210, 310, 410 from third parties.

In some embodiments, the wireless communication device 525 includes a real-time clock (RTC). The RTC increments and keeps time independently of the other inspection tool components. The RTC receives power from the power interface 515 when an external power source is connected to the inspection tool 500 and may receive power from a back-up power source when the external power source is not connected to the inspection tool 500. The RTC may timestamp the environment data from the inspection tool 500. Additionally, the RTC may enable a security feature in which the inspection tool 500 is disabled (e.g., locked-out and made inoperable) when the time of the RTC exceeds a lockout time determined by the user.

The wireless communication device 525, in some embodiments, exports environment data from the inspection tool 500 (e.g., from the inspection tool electronic processor 550). The server 110, 210, 310, 410 receives the exported information, either directly from the wireless communication device 525 or through an external device 107, and logs the data received from the inspection tool 500. As discussed in more detail below, the exported data can be used by the inspection tool 500, the external device 107, or the server 110, 210, 310, 410 to train or adapt a machine learning classifier relevant to similar inspection tools. The wireless communication device 525 may also receive information from the server 110, 210, 310, 410, the external device 107, or a second inspection tool 500. For example, the wireless communication device 525 may exchange information with a second inspection tool 500 directly, or via an external device 107.

In some embodiments, the inspection tool 500 does not communicate with the external device 107 or with the server 110, 210, 310, 410 (e.g., inspection tool 405 in FIG. 4B). Accordingly, in some embodiments, the inspection tool 500 does not include the wireless communication device 525 described above. In some embodiments, the inspection tool 500 includes a wired communication interface to communicate with, for example, the external device 107 or a different device (e.g., another inspection tool 500). The wired communication interface may provide a faster communication route than the wireless communication device 525.

In some embodiments, the inspection tool 500 includes a data sharing setting. The data sharing setting indicates what data, if any, is exported from the inspection tool 500 to the server 110, 210, 310, 410. In one embodiment, the inspection tool 500 receives (e.g., via a graphical user interface generated by the external device 107) an indication of the type of data to be exported from the inspection tool 500. In one embodiment, the external device 107 may display various options or levels of data sharing for the inspection tool 500, and the external device 107 receives the user's selection via its generated graphical user interface. For example, the inspection tool 500 may receive an indication that only environment data (e.g., motor current and voltage, number of impacts delivered, torque associated with each impact, and so forth) is to be exported from the inspection tool 500, but may not export information regarding, for example, the modes implemented by the inspection tool 500, the location of the inspection tool 500, and so forth. In some embodiments, the data sharing setting may be a binary indication of whether data regarding the operation of the inspection tool 500 (e.g., environment data) is transmitted to the server 110, 210, 310, 410. The inspection tool 500 receives the user's selection for the data sharing setting and stores the data sharing setting in memory to control the communication of the wireless communication device 525 according to the selected data sharing setting.

The electronic control assembly 536 is electrically and/or communicatively connected to a variety of modules or components of the inspection tool 500. In particular, the electronic control assembly 136 includes the electronic processor 550 (also referred to as an electronic controller), the machine learning classifier 540, and the corresponding activation switch 545. In some embodiments, the electronic processor 550 includes a plurality of electrical and electronic components that provide power, operational control, and protection to the components and modules within the electronic processor 550 and/or inspection tool 500. For example, the electronic processor 550 includes, among other things, a processing unit 557 (e.g., a microprocessor, a microcontroller, or another suitable programmable device), a memory 560, input units 565, and output units 570. The processing unit 557 includes, among other things, a control unit 572, an arithmetic logic unit (ALU) 574, and a plurality of registers 576. In some embodiments, the electronic processor 550 is implemented partially or entirely on a semiconductor (e.g., a field-programmable gate array [FPGA] semiconductor) chip or an Application Specific Integrated Circuit [ASIC], such as a chip developed through a register transfer level [RTL] design process.

The memory 560 includes, for example, a program storage area 580 and a data storage area 582. The program storage area 580 and the data storage area 582 can include combinations of different types of memory, such as read-only memory (ROM), random access memory (RAM) (e.g., dynamic RAM [DRAM], synchronous DRAM [SDRAM], and so forth), electrically erasable programmable read-only memory (EEPROM), flash memory, a hard disk, an SD card, or other suitable magnetic, optical, physical, or electronic memory devices. The electronic processor 230 is connected to the memory 560 and executes software instructions that are capable of being stored in a RAM of the memory 560 (e.g., during execution), a ROM of the memory 560 (e.g., on a generally permanent basis), or another non-transitory computer readable medium such as another memory or a disc. Software included in the implementation of the inspection tool 500 can be stored in the memory 560 of the electronic processor 550. The software includes, for example, firmware, one or more applications, program data, filters, rules, one or more program modules, and other executable instructions. In some embodiments, the machine learning classifier 540 may be stored in the memory 560 of the electronic processor 550 and are executed by the processing unit 557.

The electronic processor 550 is configured to retrieve from memory 560 and execute, among other things, instructions related to the control processes and methods described herein. The electronic processor 550 is also configured to store inspection tool information on the memory 560 including tool environment data, information identifying the type of tool, a unique identifier for the particular tool, user characteristics (e.g., identity, trade type, skill level), and other information relevant to operating or maintaining the inspection tool 500 (e.g., received from an external source, such as the external device 107 or pre-programed at the time of manufacture).

The machine learning classifier 540 is coupled to the electronic processor 550 and to the activation switch 545. The activation switch 545 switches between an activated state and a deactivated state. When the activation switch 545 is in the activated state, the electronic processor 550 is in communication with the machine learning classifier 540 and receives decision outputs from the machine learning classifier 540. When the activation switch 545 is in the deactivated state, the electronic processor 550 is not in communication with the machine learning classifier 540. In other words, the activation switch 545 selectively enables and disables the machine learning classifier 540. As described above with respect to FIGS. 1-4C, the machine learning classifier 540 includes a trained machine learning classifier that utilizes previously collected inspection tool environment data to analyze and classify new environment data from the inspection tool 500.

As shown in FIG. 5B, the machine learning classifier 540 includes an electronic processor 575 and a memory 580. The memory 580 stores a machine learning control 585. The machine learning control 585 may include a trained machine learning program as described above with respect to FIGS. 1-4C. In the illustrated embodiment, the electronic processor 575 includes a graphics processing unit. In the embodiment of FIG. 5B, the machine learning classifier 540 is positioned on a separate printed circuit board (PCB) as the electronic processor 550 of the inspection tool 500. The PCB of the electronic processor 550 and the machine learning classifier 540 are coupled with, for example, wires or cables to enable the electronic processor 550 of the inspection tool 500. In other embodiments, however, the machine learning control 585 may be stored in memory 560 of the electronic processor 550 and may be implemented by the processing unit 557. In such embodiments, the electronic control assembly 536 includes a single electronic processor 550. In yet other embodiments, the machine learning classifier 540 is implemented in the separate electronic processor 575 but is positioned on the same PCB as the electronic processor 550 of the inspection tool 500. Embodiments with the machine learning classifier 540 implemented as a separate processing unit from the electronic processor 550, whether on the same or different PCBs, allows selecting a processing unit to implement each of the machine learning classifier 540 and the electronic processor 550 that has its capabilities (e.g., processing power and memory capacity) tailored to the particular demands of each unit. Such tailoring can reduce costs and improve efficiencies of the inspection tools. In some embodiments, as illustrated in FIG. 4C, for example, the external device 107 includes the machine learning classifier 540 and the inspection tool 500 communicates with the external device 107 to receive the estimations or classifications from the machine learning classifier 540. In some embodiments, the machine learning classifier 540 is implemented in a plug-in chip or controller that is easily added to the inspection tool 500. For example, the machine learning classifier 540 may include a plug-in chip that is received within a cavity of the inspection tool 500 and connects to the electronic processor 550. For example, in some embodiments, the inspection tool 500 includes a lockable compartment including electrical contacts that is configured to receive and electrically connect to the plug-in machine learning classifier 540. The electrical contacts enable bidirectional communication between the plug-in machine learning classifier 540 and the electronic processor 550 and enable the plug-in machine learning classifier 540 to receive power from the inspection tool 500.

As discussed above with respect to FIG. 1, the machine learning control 585 may be built and operated by the server 110. In other embodiments, the machine learning control 585 may be built by the server 110 but implemented by the inspection tool 500 (similar to FIGS. 2 and 3), and in yet other embodiments, the inspection tool 500 (e.g., the electronic processor 550, electronic processor 575, or a combination thereof) builds and implements the machine learning control 585 (similar to FIG. 4B).

### Example Processes

FIGS. 6A and 6B each depict a flowchart of an example process 600 and 620 respectively that can be implemented by embodiments of the present disclosure. The process 600 generally shows in more detail determining a classification from image data while the process 620 generally shows in more details determining a command to control the inspection camera.

For clarity of presentation, the description that follows generally describes the processes 600 and 620 in the context of FIGS. 1-5B. For example, the processes 600 or 620 may be executed by the server electronic processor 425 or the electronic processor 550. However, it will be understood that the processes 600 and 620 may be performed, for example, by any other suitable system, environment, software, and hardware, or a combination of systems, environments, software, and hardware as appropriate. In some embodiments, various operations of the processes 600 and 620 can be run in parallel, in combination, in loops, or in any order. In some embodiments, the processor is housed within a mobile device or a server device. In some embodiments, the processor, the inspection camera, and the user interface are housed within an inspection tool.

For process 600, at 602, image data collected from an area of interest is received from an inspection camera. In some embodiments, the area of interest includes a pipe. In some embodiments, the aspect is a crack, a clog, a root, a buildup of fluid, running fluid, pipe wear, a transition, a connecting pipe, a joint, a misalignment, an inner lining, a belly, a leak, a pipe material or type, a wire, a stud, a nail, daylight, a hose, an outlet, a screw, a junction boxes, daylight, an item of interest, or a path aspect. In some embodiments, the path aspect includes a turn, a connection with another pipe, or a slope. In some embodiments, the image data includes video data. In some embodiments, a frequency or resolution of frames in the image data is modified depending on a speed of traversal, recently identified aspects, or device settings. In some embodiments, the image data is reduced or down sampled from collected raw image data. From 602, the process 600 proceeds to 604.

At 604, the image data is processed through a model to determine a classification for an aspect of the area of interest. In some embodiments, the model trained with previously received image data and respective previously received or determined classifications. In some embodiments, the model includes a histogram of pixel colors, shades, or saturations, mapped to a logical block. In some embodiments, the logical block includes crude logic, a CNN, a DNN, an RNN, a random forest algorithm, a decision tree algorithm, a KNN algorithm, or a logistic regression algorithm. In some embodiments, the classification is determine based on a distribution of color or brightness. In some embodiments, the model comprises a computer vision algorithm. In some embodiments, the computer vision algorithm includes SIFT, SURF, or ORB. In some embodiments, the classification is determined based on a binary decision, a decision among multiple classifications, a multiple classification problem, or a visual classification problem. In some embodiments, the model is retrained with the image data and the determined classification. In some embodiments, a confidence metric for the classification is determined based on an output filter and by processing the image data through the model. In some embodiments, the output filter includes a number of consecutive frames that the classification is determined for the aspect. In some embodiments, a command to control the inspection camera is determined based on the classification and the image data. In some embodiments, the command is provided to the inspection camera or an inspection tool housing the inspection camera. In some embodiments, the command includes at least one of slowing a frame rate of the image data, providing a user prompt to the user interface, reduce a forward speed of the inspection tool, stopping a forward progression of the inspection tool, performing a zoom function with the inspection camera, panning the inspection camera, rotating the inspection camera, switching cameras, adjusting coloring, adjusting lighting, adjusting contrast, adjusting resolution, adjusting brightness, adjusting color mapping, or augmenting a visualization the aspect on the user interface. In some embodiments, augmenting the visualization includes highlighting, magnifying, or adding a border surrounding the aspect. In some embodiments, the augmentation of the visualization is saved as part of a video, saved in another layer, saved as metadata for a video, or saved in a separate file. In some embodiments, the classification is determined by processing audio signals broadcast into the area of interest through the model along with or instead of the image data. From 604, the process 600 proceeds to 606.

At 606, a label for the aspect is determined based on the classification. In some embodiments, the label is determined by processing the classification and the image data through a second model trained with the previously received image data, the respective previously received or determined classifications, and the respective previously received or determined labels. In some embodiments, the second model is retrained with the image data, the determined classification, and the determined label. From 606, the process 600 proceeds to 608.

At 608, the label and the image data are provided to a user interface. In some embodiments, the model is retrained with a selection, provided to through the user interface, to apply or not apply the label to the aspect. In some embodiments, the selection includes metadata identifying a particular user. In some embodiments, the model is trained and personalized for the particular user. In some embodiments, the model is trained based on a distributed learning technique that merges a plurality of trainings from multiple users. In some embodiments, the multiple users are assigned weights. In some embodiments, the model is trained according to the assigned weights and respective trainings. In some embodiments, the confidence metric is provided to the user interface. In some embodiments, the user interface is configured to not display the label based on the confidence metric and a threshold value. In some embodiments, the threshold value is customized for a user via the user interface. In some embodiments, the user interface is configured to apply the label to the image data. In some embodiments, the user interface is configured to provide a prompt to confirm, deny, adjust, add, or remove the label. In some embodiments, the user interface includes an audio-based user interface that allows a user to verbally confirm, deny, adjust, add, or remove labels during operation. In some embodiments, the user interface is configured to trigger sending the image data and the label a user or a plurality of users when an “usure” prompt is selected. In some embodiments, the user interface comprises a display. In some embodiments, a pipe is displayed one-dimensionally via the user interface and as substantially straight except at a joint. In some embodiments, the user interface is configured to display a 3D representation of a pipe via stitching that is performed using a SLAM technique with the image data. In some embodiments, the user interface is configured to display a 2D representation of a pipe that includes a constant diameter pipe. In some embodiments, the 2D representation of the pipe is “unrolled” to a 1D image. In some embodiments, a notification is provided based on the classification or the label. In some embodiments, the notification includes an email, a text message, or a phone call. In some embodiments, the notification includes an audio notification, a haptic notification, or a visual notification. In some embodiments, the visual notification is provided through the user interface to highlight the aspect or the label within the image data. In some embodiments, the visual notification includes a screen flash, a highlighted border, or a pop-up. In some embodiments, the user interface provides a cropped video or compressed video based on the classification and the image data. In some embodiments, the label is provided as metadata of the image data. In some embodiments, the label is associated with a frame, a group of frames, a timestamp, a depth or a location of the inspection camera at the time of collection, or a jobsite. In some embodiments, the location of the inspection camera is determined based on a positional detection device. In some embodiments, the location is determined based on signals provided by a locating sonde. In some embodiments, the location is determined based on GPS data. In some embodiments, the inspection camera and the user interface are housed within an inspection tool. In some embodiments, the inspection tool includes a microphone, an inductive sensor, a capacitive sensor, a magnetometer, a temperature sensor, a humidity sensor, an electrical contact sensor, a motion sensor, extension sensor, inertial measurement unit, or a camera module. In some embodiments, the camera module includes the inspection camera. In some embodiments, the camera module is self-leveling and orients toward the bottom of a pipe. In some embodiments, the inspection tool comprises a drain cleaning tool, a pipe lining tool, pipe cleaning tool, a pipe internal welding tool, or a pipe internal cutting tool. In some embodiments, the inspection camera is housed within a first tool. In some embodiments, the user interface is housed within a second tool. From 608, the process 600 proceeds end.

For process 620, at 622, image data collected from an area of interest is received from an inspection camera. In some embodiments, the area of interest includes a pipe and wherein the aspect is a crack, a clog, a root, a buildup of fluid, running fluid, pipe wear, a transition, a connecting pipe, a joint, a misalignment, an inner lining, a belly, a leak, a pipe material or type, a wire, a stud, a nail, daylight, a hoses, an outlet, a screw, a junction boxes, daylight, an item of interest, or a path aspect. In some embodiments, the path aspect includes a turn, a connection with another pipe, or a slope. In some embodiments, the image data includes video data. In some embodiments, a frequency or resolution of frames in the image data is modified depending on a speed of traversal, recently identified aspects, or device settings. In some embodiments, the image data is reduced or down sampled from collected raw image data. From 622, the process 620 proceeds to 624.

At 624, a classification for an aspect of the area of interest is determined by processing the received image data through a model. In some embodiments, the model trained with previously received image data and respective previously received or determined classifications. In some embodiments, the model includes a histogram of pixel colors, shades, or saturations, mapped to a logical block. In some embodiments, the logical block includes crude logic, a CNN, a DNN, an RNN, a random forest algorithm, a decision tree algorithm, a KNN algorithm, or a logistic regression algorithm. In some embodiments, the classification is determine based on a distribution of color or brightness. In some embodiments, the model comprises a computer vision algorithm. In some embodiments, the computer vision algorithm includes SIFT, SURF, or ORB. In some embodiments, the classification is determined based on a binary decision, a decision among multiple classifications, a multiple classification problem, or a visual classification problem. In some embodiments, the classification is determined by processing audio signals broadcast into the area of interest through the model along with or instead of the image data. From 624, the process 620 proceeds to 626.

At 626, a command to control the inspection camera is determined based on the classification and the received image data. In some embodiments, the command includes at least one of slowing a frame rate of the image data, providing a user prompt to the user interface, reduce a forward speed of the inspection tool, stopping a forward progression of the inspection tool, performing a zoom function with the inspection camera, panning the inspection camera, rotating the inspection camera, switching cameras, adjusting coloring, adjusting lighting, adjusting contrast, adjusting resolution, adjusting brightness, adjusting color mapping, or augmenting a visualization the aspect on the user interface. In some embodiments, augmenting the visualization includes highlighting, magnifying, or adding a border surrounding the aspect. In some embodiments, the augmentation of the visualization is saved as part of a video, saved in another layer, saved as metadata for a video, or saved in a separate file. From 626, the process 620 proceeds to 628.

At 628, the command is provided to the inspection camera. In some embodiments, a label for the aspect is determined based on the classification. In some embodiments, the label and received image data is provided to the user interface. In some embodiments, the model is retrained with the image data and the determined classification. In some embodiments, the model is retrained with a selection, provided to through the user interface, to apply or not apply the label to the aspect. In some embodiments, the selection includes metadata identifying a particular user, and wherein the model is trained and personalized for the particular user. In some embodiments, the model is trained based on a distributed learning technique that merges a plurality of trainings from multiple users. In some embodiments, the multiple users are assigned weights, and wherein the model is trained according to the assigned weights and respective trainings. In some embodiments, the label is determined by processing the classification and the image data through a second model trained with the previously received image data, the respective previously received or determined classifications, and the respective previously received or determined labels. In some embodiments, the second model is retrained with the image data, the determined classification, and the determined label. In some embodiments, a confidence metric for the classification is determined based on an output filter and by processing the image data through the model. In some embodiments, the confidence metric is provided to the user interface. In some embodiments, the output filter includes a number of consecutive frames that the classification is determined for the aspect. In some embodiments, the user interface is configured to not display the label based on the confidence metric and a threshold value. In some embodiments, the threshold value is customized for a user via the user interface. In some embodiments, the user interface is configured to apply the label to the image data. In some embodiments, the user interface is configured to provide a prompt to confirm, deny, adjust, add, or remove the label. In some embodiments, the user interface includes an audio-based user interface that allows a user to verbally confirm, deny, adjust, add, or remove labels during operation. In some embodiments, the user interface is configured to trigger sending the image data and the label a user or a plurality of users when an “usure” prompt is selected. In some embodiments, the user interface comprises a display. In some embodiments, a pipe is displayed one-dimensionally via the user interface and as substantially straight except at a joint. In some embodiments, the user interface is configured to display a 3D representation of a pipe via stitching that is performed using a SLAM technique with the image data. In some embodiments, the user interface is configured to display a 2D representation of a pipe that includes a constant diameter pipe, and wherein the 2D representation of the pipe is “unrolled” to a 1D image. In some embodiments, a notification determined based on the classification, the label, or the command is provided. In some embodiments, the notification includes an email, a text message, or a phone call. In some embodiments, the notification includes an audio notification, a haptic notification, or a visual notification. In some embodiments, the visual notification is provided through the user interface to highlight the aspect or the label within the image data. In some embodiments, the visual notification includes a screen flash, a highlighted border, or a pop-up. In some embodiments, the user interface provides a cropped video or compressed video based on the classification and the image data. In some embodiments, the label is provided as metadata of the image data. In some embodiments, the label is associated with a frame, a group of frames, a timestamp, a depth or a location of the inspection camera at the time of collection, or a jobsite. In some embodiments, the location of the inspection camera is determined based on a positional detection device. In some embodiments, the location is determined based on signals provided by a locating sonde. In some embodiments, the location is determined based on GPS data. In some embodiments, the inspection camera and the user interface are housed within an inspection tool. In some embodiments, the inspection tool includes a microphone, an inductive sensor, a capacitive sensor, a magnetometer, a temperature sensor, a humidity sensor, an electrical contact sensor, a motion sensor, extension sensor, inertial measurement unit, or a camera module. In some embodiments, the camera module includes the inspection camera. In some embodiments, the camera module is self-leveling and orients toward the bottom of a pipe. In some embodiments, the inspection tool comprises a drain cleaning tool, a pipe lining tool, pipe cleaning tool, a pipe internal welding tool, or a pipe internal cutting tool. In some embodiments, the inspection camera is housed within a first tool. In some embodiments, the user interface is housed within a second tool. From 628, the process 620 ends.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Moreover, the separation or integration of various system modules and components in the implementations described earlier should not be understood as requiring such separation or integration in all implementations, and it should be understood that the described components and systems can generally be integrated together in a single product or packaged into multiple products. Accordingly, the earlier description of example embodiments does not define or constrain this disclosure. Other changes, substitutions, and alterations are also possible without departing from the spirit and scope of this disclosure.

Thus, this description provides, among other things, an inspection tool system that can be deployed within an environment and employed identify various aspects of the environment through a train machine learning classifier.

### EXAMPLE CONFIGURATIONS

Various aspects of the present disclosure may take any one or more of the following example configurations:

EEE(1) A system for determining a classification from image data, comprising: a processor configured to receive, from an inspection camera, image data collected from an area of interest, process the image data through a model to determine a classification for an aspect of the area of interest, the model trained with previously received image data and respective previously received or determined classifications, determine, based on the classification, a label for the aspect, and provide the label and the image data to a user interface.

EEE(2) The system for determining a classification from image data according to EEE(1), wherein the model includes a histogram of pixel colors, shades, or saturations, mapped to a logical block.

EEE(3) The system for determining a classification from image data according to any one of EEE(1) or EEE(2), wherein the logical block includes crude logic, a CNN, a DNN, an RNN, a random forest algorithm, a decision tree algorithm, a KNN algorithm, or a logistic regression algorithm.

EEE(4) The system for determining a classification from image data according to any one of EEE(1) to EEE(3), wherein the classification is determine based on a distribution of color or brightness.

EEE(5) The system for determining a classification from image data according to any one of EEE(1) to EEE(4), wherein the model comprises a computer vision algorithm.

EEE(6) The system for determining a classification from image data according to any one of EEE(1) to EEE(5), wherein the computer vision algorithm includes SIFT, SURF, or ORB.

EEE(7) The system for determining a classification from image data according to any one of EEE(1) to EEE(6), wherein the classification is determined based on a binary decision, a decision among multiple classifications, a multiple classification problem, or a visual classification problem.

EEE(8) The system for determining a classification from image data according to any one of EEE(1) to EEE(7), wherein the model is retrained with the image data and the determined classification.

EEE(9) The system for determining a classification from image data according to any one of EEE(1) to EEE(8), wherein the model is retrained with a selection, provided to through the user interface, to apply or not apply the label to the aspect.

EEE(10) The system for determining a classification from image data according to any one of EEE(1) to EEE(9), wherein the selection includes metadata identifying a particular user, and wherein the model is trained and personalized for the particular user.

EEE(11) The system for determining a classification from image data according to any one of EEE(1) to EEE(10), wherein the model is trained based on a distributed learning technique that merges a plurality of trainings from multiple users.

EEE(12) The system for determining a classification from image data according to any one of EEE(1) to EEE(11), wherein the multiple users are assigned weights, and wherein the model is trained according to the assigned weights and respective trainings.

EEE(13) The system for determining a classification from image data according to any one of EEE(1) to EEE(12), wherein the label is determined by processing the classification and the image data through a second model trained with the previously received image data, the respective previously received or determined classifications, and the respective previously received or determined labels.

EEE(14) The system for determining a classification from image data according to any one of EEE(1) to EEE(13), wherein the second model is retrained with the image data, the determined classification, and the determined label.

EEE(15) The system for determining a classification from image data according to any one of EEE(1) to EEE(14), wherein the processor is further configured to determine, based on an output filter and by processing the image data through the model, a confidence metric for the classification, and provide the confidence metric to the user interface.

EEE(16) The system for determining a classification from image data according to any one of EEE(1) to EEE(15), wherein the output filter includes a number of consecutive frames that the classification is determined for the aspect.

EEE(17) The system for determining a classification from image data according to any one of EEE(1) to EEE(16), wherein the user interface is configured to not display the label based on the confidence metric and a threshold value.

EEE(18) The system for determining a classification from image data according to any one of EEE(1) to EEE(17), wherein the threshold value is customized for a user via the user interface.

EEE(19) The system for determining a classification from image data according to any one of EEE(1) to EEE(18), wherein the processor is further configured to determine, based on the classification and the image data, a command to control the inspection camera; and provide the command to the inspection camera or an inspection tool housing the inspection camera.

EEE(20) The system for determining a classification from image data according to any one of EEE(1) to EEE(19), wherein the command includes at least one of slowing a frame rate of the image data, providing a user prompt to the user interface, reduce a forward speed of the inspection tool, stopping a forward progression of the inspection tool, performing a zoom function with the inspection camera, panning the inspection camera, rotating the inspection camera, switching cameras, adjusting coloring, adjusting lighting, adjusting contrast, adjusting resolution, adjusting brightness, adjusting color mapping, or augmenting a visualization the aspect on the user interface.

EEE(21) The system for determining a classification from image data according to any one of EEE(1) to EEE(20), wherein augmenting the visualization includes highlighting, magnifying, or adding a border surrounding the aspect.

EEE(22) The system for determining a classification from image data according to any one of EEE(1) to EEE(21), wherein the augmentation of the visualization is saved as part of a video, saved in another layer, saved as metadata for a video, or saved in a separate file.

EEE(23) The system for determining a classification from image data according to any one of EEE(1) to EEE(22), wherein the user interface is configured to apply the label to the image data.

EEE(24) The system for determining a classification from image data according to any one of EEE(1) to EEE(23), wherein the user interface is configured to provide a prompt to confirm, deny, adjust, add, or remove the label.

EEE(25) The system for determining a classification from image data according to any one of EEE(1) to EEE(24), wherein the user interface includes an audio-based user interface that allows a user to verbally confirm, deny, adjust, add, or remove labels during operation.

EEE(26) The system for determining a classification from image data according to any one of EEE(1) to EEE(25), wherein the user interface is configured to trigger sending the image data and the label a user or a plurality of users when an “usure” prompt is selected.

EEE(27) The system for determining a classification from image data according to any one of EEE(1) to EEE(26), wherein the user interface comprises a display.

EEE(28) The system for determining a classification from image data according to any one of EEE(1) to EEE(27), wherein a pipe is displayed one-dimensionally via the user interface and as substantially straight except at a joint.

EEE(29) The system for determining a classification from image data according to any one of EEE(1) to EEE(28), wherein the user interface is configured to display a 3D representation of a pipe via stitching that is performed using a SLAM technique with the image data.

EEE(30) The system for determining a classification from image data according to any one of EEE(1) to EEE(29), wherein the user interface is configured to display a 2D representation of a pipe that includes a constant diameter pipe, and wherein the 2D representation of the pipe is “unrolled” to a 1D image.

EEE(31) The system for determining a classification from image data according to any one of EEE(1) to EEE(30), wherein the processor is further configured to provide a notification based on the classification or the label.

EEE(32) The system for determining a classification from image data according to any one of EEE(1) to EEE(31), wherein the notification includes an email, a text message, or a phone call.

EEE(33) The system for determining a classification from image data according to any one of EEE(1) to EEE(32), wherein the notification includes an audio notification, a haptic notification, or a visual notification.

EEE(34) The system for determining a classification from image data according to any one of EEE(1) to EEE(33), wherein the visual notification is provided through the user interface to highlight the aspect or the label within the image data.

EEE(35) The system for determining a classification from image data according to any one of EEE(1) to EEE(34), wherein the visual notification includes a screen flash, a highlighted border, or a pop-up.

EEE(36) The system for determining a classification from image data according to any one of EEE(1) to EEE(35), wherein the user interface provides a cropped video or compressed video based on the classification and the image data.

EEE(37) The system for determining a classification from image data according to any one of EEE(1) to EEE(36), wherein the area of interest includes a pipe and wherein the aspect is a crack, a clog, a root, a buildup of fluid, running fluid, pipe wear, a transition, a connecting pipe, a joint, a misalignment, an inner lining, a belly, a leak, a pipe material or type, a wire, a stud, a nail, daylight, a hoses, an outlet, a screw, a junction boxes, daylight, an item of interest, or a path aspect.

EEE(38) The system for determining a classification from image data according to any one of EEE(1) to EEE(37), wherein the path aspect includes a turn, a connection with another pipe, or a slope.

EEE(39) The system for determining a classification from image data according to any one of EEE(1) to EEE(38), wherein the image data includes video data.

EEE(40) The system for determining a classification from image data according to any one of EEE(1) to EEE(39), wherein a frequency or resolution of frames in the image data is modified depending on a speed of traversal, recently identified aspects, or device settings.

EEE(41) The system for determining a classification from image data according to any one of EEE(1) to EEE(40), wherein the label is provided as metadata of the image data.

EEE(42) The system for determining a classification from image data according to any one of EEE(1) to EEE(41), wherein the label is associated with a frame, a group of frames, a timestamp, a depth or a location of the inspection camera at the time of collection, or a jobsite.

EEE(43) The system for determining a classification from image data according to any one of EEE(1) to EEE(42), wherein the location of the inspection camera is determined based on a positional detection device.

EEE(44) The system for determining a classification from image data according to any one of EEE(1) to EEE(43), wherein the location is determined based on signals provided by a locating sonde.

EEE(45) The system for determining a classification from image data according to any one of EEE(1) to EEE(44), wherein the location is determined based on GPS data.

EEE(46) The system for determining a classification from image data according to any one of EEE(1) to EEE(45), wherein the image data is reduced or down sampled from collected raw image data.

EEE(47) The system for determining a classification from image data according to any one of EEE(1) to EEE(46), wherein the processor is housed within a mobile device or a server device.

EEE(48) The system for determining a classification from image data according to any one of EEE(1) to EEE(47), wherein the inspection camera and the user interface are housed within an inspection tool.

EEE(49) The system for determining a classification from image data according to any one of EEE(1) to EEE(48), wherein the inspection camera is housed within a first tool, and wherein the user interface is housed within a second tool.

EEE(50) The system for determining a classification from image data according to any one of EEE(1) to EEE(49), wherein the processor, the inspection camera, and the user interface are housed within an inspection tool.

EEE(51) The system for determining a classification from image data according to any one of EEE(1) to EEE(50), wherein the inspection tool comprises a drain cleaning tool, a pipe lining tool, pipe cleaning tool, a pipe internal welding tool, or a pipe internal cutting tool.

EEE(52) The system for determining a classification from image data according to any one of EEE(1) to EEE(51), wherein the inspection tool includes a microphone, an inductive sensor, a capacitive sensor, a magnetometer, a temperature sensor, a humidity sensor, an electrical contact sensor, a motion sensor, extension sensor, inertial measurement unit, or a camera module.

EEE(53) The system for determining a classification from image data according to any one of EEE(1) to EEE(52), wherein the camera module includes the inspection camera, and wherein the camera module is self-leveling and orients toward the bottom of a pipe.

EEE(54) The system for determining a classification from image data according to any one of EEE(1) to EEE(53), wherein the classification is determined by processing audio signals broadcast into the area of interest through the model along with or instead of the image data.

EEE(55) An inspection tool comprising: a housing; a user interface supported by the housing; an inspection reel supported by the housing and including an inspection camera configured to captured image data; a controller comprising a processor and a memory, the controller supported by the housing and coupled to the inspection camera and the user interface, wherein the processor is configured to receive, from the inspection camera, image data collected from an area of interest, process the received image data through a model to determine a classification for an aspect of the area of interest, the model trained with previously received image data and respective previously received or determined classifications, determine, based on the classification, a label for the aspect, and provide the label and received image data to the user interface.

EEE(56) The inspection tool according to EEE(55), wherein the model includes a histogram of pixel colors, shades, or saturations, mapped to a logical block.

EEE(57) The inspection tool according to any one of EEE(55) or EEE(56), wherein the logical block includes crude logic, a CNN, a DNN, an RNN, a random forest algorithm, a decision tree algorithm, a KNN algorithm, or a logistic regression algorithm.

EEE(58) The inspection tool according to any one of EEE(55) to EEE(57), wherein the classification is determine based on a distribution of color or brightness.

EEE(59) The inspection tool according to any one of EEE(55) to EEE(58), wherein the model comprises a computer vision algorithm.

EEE(60) The inspection tool according to any one of EEE(55) to EEE(59), wherein the computer vision algorithm includes SIFT, SURF, or ORB.

EEE(61) The inspection tool according to any one of EEE(55) to EEE(60), wherein the classification is determined based on a binary decision, a decision among multiple classifications, a multiple classification problem, or a visual classification problem.

EEE(62) The inspection tool according to any one of EEE(55) to EEE(61), wherein the model is retrained with the image data and the determined classification.

EEE(63) The inspection tool according to any one of EEE(55) to EEE(62), wherein the model is retrained with a selection, provided to through the user interface, to apply or not apply the label to the aspect.

EEE(64) The inspection tool according to any one of EEE(55) to EEE(63), wherein the selection includes metadata identifying a particular user, and wherein the model is trained and personalized for the particular user.

EEE(65) The inspection tool according to any one of EEE(55) to EEE(64), wherein the model is trained based on a distributed learning technique that merges a plurality of trainings from multiple users.

EEE(66) The inspection tool according to any one of EEE(55) to EEE(65), wherein the multiple users are assigned weights, and wherein the model is trained according to the assigned weights and respective trainings.

EEE(67) The inspection tool according to any one of EEE(55) to EEE(66), wherein the label is determined by processing the classification and the image data through a second model trained with the previously received image data, the respective previously received or determined classifications, and the respective previously received or determined labels.

EEE(68) The inspection tool according to any one of EEE(55) to EEE(67), wherein the second model is retrained with the image data, the determined classification, and the determined label.

EEE(69) The inspection tool according to any one of EEE(55) to EEE(68), wherein the processor is further configured to determine, based on an output filter and by processing the image data through the model, a confidence metric for the classification, and provide the confidence metric to the user interface.

EEE(70) The inspection tool according to any one of EEE(55) to EEE(69), wherein the output filter includes a number of consecutive frames that the classification is determined for the aspect.

EEE(71) The inspection tool according to any one of EEE(55) to EEE(70), wherein the user interface is configured to not display the label based on the confidence metric and a threshold value.

EEE(72) The inspection tool according to any one of EEE(55) to EEE(71), wherein the threshold value is customized for a user via the user interface.

EEE(73) The inspection tool according to any one of EEE(55) to EEE(72), wherein the processor is further configured to determine, based on the classification and the image data, a command to control the inspection camera; and provide the command to the inspection camera.

EEE(74) The inspection tool according to any one of EEE(55) to EEE(73), wherein the command includes at least one of slowing a frame rate of the image data, providing a user prompt to the user interface, reduce a forward speed of the inspection tool, stopping a forward progression of the inspection tool, performing a zoom function with the inspection camera, panning the inspection camera, rotating the inspection camera, switching cameras, adjusting coloring, adjusting lighting, adjusting contrast, adjusting resolution, adjusting brightness, adjusting color mapping, or augmenting a visualization the aspect on the user interface.

EEE(75) The inspection tool according to any one of EEE(55) to EEE(74), wherein augmenting the visualization includes highlighting, magnifying, or adding a border surrounding the aspect.

EEE(76) The inspection tool according to any one of EEE(55) to EEE(75), wherein the augmentation of the visualization is saved as part of a video, saved in another layer, saved as metadata for a video, or saved in a separate file.

EEE(77) The inspection tool according to any one of EEE(55) to EEE(76), wherein the user interface is configured to apply the label to the image data.

EEE(78) The inspection tool according to any one of EEE(55) to EEE(77), wherein the user interface is configured to provide a prompt to confirm, deny, adjust, add, or remove the label.

EEE(79) The inspection tool according to any one of EEE(55) to EEE(78), wherein the user interface includes an audio-based user interface that allows a user to verbally confirm, deny, adjust, add, or remove labels during operation.

EEE(80) The inspection tool according to any one of EEE(55) to EEE(79), wherein the user interface is configured to trigger sending the image data and the label a user or a plurality of users when an “usure” prompt is selected.

EEE(81) The inspection tool according to any one of EEE(55) to EEE(80), wherein the user interface comprises a display.

EEE(82) The inspection tool according to any one of EEE(55) to EEE(81), wherein a pipe is displayed one-dimensionally via the user interface and as substantially straight except at a joint.

EEE(83) The inspection tool according to any one of EEE(55) to EEE(82), wherein the user interface is configured to display a 3D representation of a pipe via stitching that is performed using a SLAM technique with the image data.

EEE(84) The inspection tool according to any one of EEE(55) to EEE(83), wherein the user interface is configured to display a 2D representation of a pipe that includes a constant diameter pipe, and wherein the 2D representation of the pipe is “unrolled” to a 1D image.

EEE(85) The inspection tool according to any one of EEE(55) to EEE(84), wherein the processor is further configured to provide a notification based on the classification or the label.

EEE(86) The inspection tool according to any one of EEE(55) to EEE(85), wherein the notification includes an email, a text message, or a phone call.

EEE(87) The inspection tool according to any one of EEE(55) to EEE(86), wherein the notification includes an audio notification, a haptic notification, or a visual notification.

EEE(88) The inspection tool according to any one of EEE(55) to EEE(87), wherein the visual notification is provided through the user interface to highlight the aspect or the label within the image data.

EEE(89) The inspection tool according to any one of EEE(55) to EEE(88), wherein the visual notification includes a screen flash, a highlighted border, or a pop-up.

EEE(90) The inspection tool according to any one of EEE(55) to EEE(89), wherein the user interface provides a cropped video or compressed video based on the classification and the image data.

EEE(91) The inspection tool according to any one of EEE(55) to EEE(90), wherein the area of interest includes a pipe and wherein the aspect is a crack, a clog, a root, a buildup of fluid, running fluid, pipe wear, a transition, a connecting pipe, a joint, a misalignment, an inner lining, a belly, a leak, a pipe material or type, a wire, a stud, a nail, daylight, a hoses, an outlet, a screw, a junction boxes, daylight, an item of interest, or a path aspect.

EEE(92) The inspection tool according to any one of EEE(55) to EEE(91), wherein the path aspect includes a turn, a connection with another pipe, or a slope.

EEE(93) The inspection tool according to any one of EEE(55) to EEE(92), wherein the image data includes video data.

EEE(94) The inspection tool according to any one of EEE(55) to EEE(93), wherein a frequency or resolution of frames in the image data is modified depending on a speed of traversal, recently identified aspects, or device settings.

EEE(95) The inspection tool according to any one of EEE(55) to EEE(94), wherein the label is provided as metadata of the image data.

EEE(96) The inspection tool according to any one of EEE(55) to EEE(95), wherein the label is associated with a frame, a group of frames, a timestamp, a depth or a location of the inspection camera at the time of collection, or a jobsite.

EEE(97) The inspection tool according to any one of EEE(55) to EEE(96), wherein the location of the inspection camera is determined based on a positional detection device.

EEE(98) The inspection tool according to any one of EEE(55) to EEE(97), wherein the location is determined based on signals provided by a locating sonde.

EEE(99) The inspection tool according to any one of EEE(55) to EEE(98), wherein the location is determined based on GPS data.

EEE(100) The inspection tool according to any one of EEE(55) to EEE(99), wherein the image data is reduced or down sampled from collected raw image data.

EEE(101) The inspection tool according to any one of EEE(55) to EEE(100), comprising a drain cleaning tool, a pipe lining tool, pipe cleaning tool, a pipe internal welding tool, or a pipe internal cutting tool.

EEE(102) The inspection tool according to any one of EEE(55) to EEE(101), comprising a microphone, an inductive sensor, a capacitive sensor, a magnetometer, a temperature sensor, a humidity sensor, an electrical contact sensor, a motion sensor, extension sensor, inertial measurement unit, or a camera module.

EEE(103) The inspection tool according to any one of EEE(55) to EEE(102), wherein the camera module includes the inspection camera, and wherein the camera module is self-leveling and orients toward the bottom of a pipe.

EEE(104) The inspection tool according to any one of EEE(55) to EEE(103), wherein the classification is determined by processing audio signals broadcast into the area of interest through the model along with or instead of the image data.

EEE(105) A method for determining a classification from image data, the method comprising: receiving, from an inspection camera, image data collected from an area of interest; processing the image data through a model to determine a classification for an aspect of the area of interest, the model trained with previously received image data and respective previously received or determined classifications; determining, based on the classification, a label for the aspect; and providing the label and image data to a user interface.

EEE(106) The method for determining a classification from image data according to EEE(105), wherein the model includes a histogram of pixel colors, shades, or saturations, mapped to a logical block.

EEE(107) The method for determining a classification from image data according to any one of EEE(105) or EEE(106), wherein the logical block includes crude logic, a CNN, a DNN, an RNN, a random forest algorithm, a decision tree algorithm, a KNN algorithm, or a logistic regression algorithm.

EEE(108) The method for determining a classification from image data according to any one of EEE(105) to EEE(107), wherein the classification is determine based on a distribution of color or brightness.

EEE(109) The method for determining a classification from image data according to any one of EEE(105) to EEE(108), wherein the model comprises a computer vision algorithm.

EEE(110) The method for determining a classification from image data according to any one of EEE(105) to EEE(109), wherein the computer vision algorithm includes SIFT, SURF, or ORB.

EEE(111) The method for determining a classification from image data according to any one of EEE(105) to EEE(110), wherein the classification is determined based on a binary decision, a decision among multiple classifications, a multiple classification problem, or a visual classification problem.

EEE(112) The method for determining a classification from image data according to any one of EEE(105) to EEE(111), wherein the model is retrained with the image data and the determined classification.

EEE(113) The method for determining a classification from image data according to any one of EEE(105) to EEE(112), wherein the model is retrained with a selection, provided to through the user interface, to apply or not apply the label to the aspect.

EEE(114) The method for determining a classification from image data according to any one of EEE(105) to EEE(113), wherein the selection includes metadata identifying a particular user, and wherein the model is trained and personalized for the particular user.

EEE(115) The method for determining a classification from image data according to any one of EEE(105) to EEE(114), wherein the model is trained based on a distributed learning technique that merges a plurality of trainings from multiple users.

EEE(116) The method for determining a classification from image data according to any one of EEE(105) to EEE(115), wherein the multiple users are assigned weights, and wherein the model is trained according to the assigned weights and respective trainings.

EEE(117) The method for determining a classification from image data according to any one of EEE(105) to EEE(116), wherein the label is determined by processing the classification and the image data through a second model trained with the previously received image data, the respective previously received or determined classifications, and the respective previously received or determined labels.

EEE(118) The method for determining a classification from image data according to any one of EEE(105) to EEE(117), wherein the second model is retrained with the image data, the determined classification, and the determined label.

EEE(119) The method for determining a classification from image data according to any one of EEE(105) to EEE(118), further comprising determining, based on an output filter and by processing the image data through the model, a confidence metric for the classification, and providing the confidence metric to the user interface.

EEE(120) The method for determining a classification from image data according to any one of EEE(105) to EEE(119), wherein the output filter includes a number of consecutive frames that the classification is determined for the aspect.

EEE(121) The method for determining a classification from image data according to any one of EEE(105) to EEE(120), wherein the user interface is configured to not display the label based on the confidence metric and a threshold value.

EEE(122) The method for determining a classification from image data according to any one of EEE(105) to EEE(121), wherein the threshold value is customized for a user via the user interface.

EEE(123) The method for determining a classification from image data according to any one of EEE(105) to EEE(122), further comprising determining, based on the classification and the image data, a command to control the inspection camera; and providing the command to the inspection camera or an inspection tool housing the inspection camera.

EEE(124) The method for determining a classification from image data according to any one of EEE(105) to EEE(123), wherein the command includes at least one of slowing a frame rate of the image data, providing a user prompt to the user interface, reduce a forward speed of the inspection tool, stopping a forward progression of the inspection tool, performing a zoom function with the inspection camera, panning the inspection camera, rotating the inspection camera, switching cameras, adjusting coloring, adjusting lighting, adjusting contrast, adjusting resolution, adjusting brightness, adjusting color mapping, or augmenting a visualization the aspect on the user interface.

EEE(125) The method for determining a classification from image data according to any one of EEE(105) to EEE(124), wherein augmenting the visualization includes highlighting, magnifying, or adding a border surrounding the aspect.

EEE(126) The method for determining a classification from image data according to any one of EEE(105) to EEE(125), wherein the augmentation of the visualization is saved as part of a video, saved in another layer, saved as metadata for a video, or saved in a separate file.

EEE(127) The method for determining a classification from image data according to any one of EEE(105) to EEE(126), wherein the user interface is configured to apply the label to the image data.

EEE(128) The method for determining a classification from image data according to any one of EEE(105) to EEE(127), wherein the user interface is configured to provide a prompt to confirm, deny, adjust, add, or remove the label.

EEE(129) The method for determining a classification from image data according to any one of EEE(105) to EEE(128), wherein the user interface includes an audio-based user interface that allows a user to verbally confirm, deny, adjust, add, or remove labels during operation.

EEE(130) The method for determining a classification from image data according to any one of EEE(105) to EEE(129), wherein the user interface is configured to trigger sending the image data and the label a user or a plurality of users when an “usure” prompt is selected.

EEE(131) The method for determining a classification from image data according to any one of EEE(105) to EEE(130), wherein the user interface comprises a display.

EEE(132) The method for determining a classification from image data according to any one of EEE(105) to EEE(131), wherein a pipe is displayed one-dimensionally via the user interface and as substantially straight except at a joint.

EEE(133) The method for determining a classification from image data according to any one of EEE(105) to EEE(132), wherein the user interface is configured to display a three-dimensional (3D) representation of a pipe via stitching that is performed using a SLAM technique with the image data.

EEE(134) The method for determining a classification from image data according to any one of EEE(105) to EEE(133), wherein the user interface is configured to display a 2D representation of a pipe that includes a constant diameter pipe, and wherein the 2D representation of the pipe is “unrolled” to alD image.

EEE(135) The method for determining a classification from image data according to any one of EEE(105) to EEE(134), further comprising providing a notification based on the classification or the label.

EEE(136) The method for determining a classification from image data according to any one of EEE(105) to EEE(135), wherein the notification includes an email, a text message, or a phone call.

EEE(137) The method for determining a classification from image data according to any one of EEE(105) to EEE(136), wherein the notification includes an audio notification, a haptic notification, or a visual notification.

EEE(138) The method for determining a classification from image data according to any one of EEE(105) to EEE(137), wherein the visual notification is provided through the user interface to highlight the aspect or the label within the image data.

EEE(139) The method for determining a classification from image data according to any one of EEE(105) to EEE(138), wherein the visual notification includes a screen flash, a highlighted border, or a pop-up.

EEE(140) The method for determining a classification from image data according to any one of EEE(105) to EEE(139), wherein the user interface provides a cropped video or compressed video based on the classification and the image data.

EEE(141) The method for determining a classification from image data according to any one of EEE(105) to EEE(140), wherein the area of interest includes a pipe and wherein the aspect is a crack, a clog, a root, a buildup of fluid, running fluid, pipe wear, a transition, a connecting pipe, a joint, a misalignment, an inner lining, a belly, a leak, a pipe material or type, a wire, a stud, a nail, daylight, a hoses, an outlet, a screw, a junction boxes, daylight, an item of interest, or a path aspect.

EEE(142) The method for determining a classification from image data according to any one of EEE(105) to EEE(141), wherein the path aspect includes a turn, a connection with another pipe, or a slope.

EEE(143) The method for determining a classification from image data according to any one of EEE(105) to EEE(142), wherein the image data includes video data.

EEE(144) The method for determining a classification from image data according to any one of EEE(105) to EEE(143), wherein a frequency or resolution of frames in the image data is modified depending on a speed of traversal, recently identified aspects, or device settings.

EEE(145) The method for determining a classification from image data according to any one of EEE(105) to EEE(144), wherein the label is provided as metadata of the image data.

EEE(146) The method for determining a classification from image data according to any one of EEE(105) to EEE(145), wherein the label is associated with a frame, a group of frames, a timestamp, a depth or a location of the inspection camera at the time of collection, or a jobsite.

EEE(147) The method for determining a classification from image data according to any one of EEE(105) to EEE(146), wherein the location of the inspection camera is determined based on a positional detection device.

EEE(148) The method for determining a classification from image data according to any one of EEE(105) to EEE(147), wherein the location is determined based on signals provided by a locating sonde.

EEE(149) The method for determining a classification from image data according to any one of EEE(105) to EEE(148), wherein the location is determined based on GPS data.

EEE(150) The method for determining a classification from image data according to any one of EEE(105) to EEE(149), wherein the image data is reduced or down sampled from collected raw image data.

EEE(151) The method for determining a classification from image data according to any one of EEE(105) to EEE(150), wherein the method is executed by a processor that is housed within a mobile device or a server device.

EEE(152) The method for determining a classification from image data according to any one of EEE(105) to EEE(151), wherein the inspection camera and the user interface are housed within an inspection tool.

EEE(153) The method for determining a classification from image data according to any one of EEE(105) to EEE(152), wherein the inspection camera is housed within a first tool, and wherein the user interface is housed within a second tool.

EEE(154) The method for determining a classification from image data according to any one of EEE(105) to EEE(153), wherein method is executed by a processor housed within an inspection tool, and wherein the inspection camera and the user interface are housed within the inspection tool.

EEE(155) The method for determining a classification from image data according to any one of EEE(105) to EEE(154), wherein the inspection tool comprises a drain cleaning tool, a pipe lining tool, pipe cleaning tool, a pipe internal welding tool, or a pipe internal cutting tool.

EEE(156) The method for determining a classification from image data according to any one of EEE(105) to EEE(155), wherein the inspection tool includes a microphone, an inductive sensor, a capacitive sensor, a magnetometer, a temperature sensor, a humidity sensor, an electrical contact sensor, a motion sensor, extension sensor, inertial measurement unit, or a camera module.

EEE(157) The method for determining a classification from image data according to any one of EEE(105) to EEE(156), wherein the camera module includes the inspection camera, and wherein the camera module is self-leveling and orients toward the bottom of a pipe.

EEE(158) The method for determining a classification from image data according to any one of EEE(105) to EEE(157), wherein the classification is determined by processing audio signals broadcast into the area of interest through the model along with or instead of the image data.

EEE(159) A non-transitory computer-readable medium including instructions executable by an electronic processor to perform a set of functions, the set of functions comprising: receiving, from an inspection camera, image data collected from an area of interest; processing the image data through a model to determine a classification for an aspect of the area of interest, the model trained with previously received image data and respective previously received or determined classifications; determining, based on the classification, a label for the aspect; and providing the label and image data to a user interface.

EEE(160) The medium according to EEE(159), wherein the model includes a histogram of pixel colors, shades, or saturations, mapped to a logical block.

EEE(161) The medium according to any one of EEE(159) or EEE(160), wherein the logical block includes crude logic, a CNN, a DNN, an RNN, a random forest algorithm, a decision tree algorithm, a KNN algorithm, or a logistic regression algorithm.

EEE(162) The medium according to any one of EEE(159) to EEE(161), wherein the classification is determine based on a distribution of color or brightness.

EEE(163) The medium according to any one of EEE(159) to EEE(162), wherein the model comprises a computer vision algorithm.

EEE(164) The medium according to any one of EEE(159) to EEE(163), wherein the computer vision algorithm includes SIFT, SURF, or ORB.

EEE(165) The medium according to any one of EEE(159) to EEE(164), wherein the classification is determined based on a binary decision, a decision among multiple classifications, a multiple classification problem, or a visual classification problem.

EEE(166) The medium according to any one of EEE(159) to EEE(165), wherein the model is retrained with the image data and the determined classification.

EEE(167) The medium according to any one of EEE(159) to EEE(166), wherein the model is retrained with a selection, provided to through the user interface, to apply or not apply the label to the aspect.

EEE(168) The medium according to any one of EEE(159) to EEE(167), wherein the selection includes metadata identifying a particular user, and wherein the model is trained and personalized for the particular user.

EEE(169) The medium according to any one of EEE(159) to EEE(168), wherein the model is trained based on a distributed learning technique that merges a plurality of trainings from multiple users.

EEE(170) The medium according to any one of EEE(159) to EEE(169), wherein the multiple users are assigned weights, and wherein the model is trained according to the assigned weights and respective trainings.

EEE(171) The medium according to any one of EEE(159) to EEE(170), wherein the label is determined by processing the classification and the image data through a second model trained with the previously received image data, the respective previously received or determined classifications, and the respective previously received or determined labels.

EEE(172) The medium according to any one of EEE(159) to EEE(171), wherein the second model is retrained with the image data, the determined classification, and the determined label.

EEE(173) The medium according to any one of EEE(159) to EEE(172), wherein the set of functions further comprise: determining, based on an output filter and by processing the image data through the model, a confidence metric for the classification, and providing the confidence metric to the user interface.

EEE(174) The medium according to any one of EEE(159) to EEE(173), wherein the output filter includes a number of consecutive frames that the classification is determined for the aspect.

EEE(175) The medium according to any one of EEE(159) to EEE(174), wherein the user interface is configured to not display the label based on the confidence metric and a threshold value.

EEE(176) The medium according to any one of EEE(159) to EEE(175), wherein the threshold value is customized for a user via the user interface.

EEE(177) The medium according to any one of EEE(159) to EEE(176), wherein the set of functions further comprise: determining, based on the classification and the image data, a command to control the inspection camera; and providing the command to the inspection camera or an inspection tool housing the inspection camera.

EEE(178) The medium according to any one of EEE(159) to EEE(177), wherein the command includes at least one of slowing a frame rate of the image data, providing a user prompt to the user interface, reduce a forward speed of the inspection tool, stopping a forward progression of the inspection tool, performing a zoom function with the inspection camera, panning the inspection camera, rotating the inspection camera, switching cameras, adjusting coloring, adjusting lighting, adjusting contrast, adjusting resolution, adjusting brightness, adjusting color mapping, or augmenting a visualization the aspect on the user interface.

EEE(179) The medium according to any one of EEE(159) to EEE(178), wherein augmenting the visualization includes highlighting, magnifying, or adding a border surrounding the aspect.

EEE(180) The medium according to any one of EEE(159) to EEE(179), wherein the augmentation of the visualization is saved as part of a video, saved in another layer, saved as metadata for a video, or saved in a separate file.

EEE(181) The medium according to any one of EEE(159) to EEE(180), wherein the user interface is configured to apply the label to the image data.

EEE(182) The medium according to any one of EEE(159) to EEE(181), wherein the user interface is configured to provide a prompt to confirm, deny, adjust, add, or remove the label.

EEE(183) The medium according to any one of EEE(159) to EEE(182), wherein the user interface includes an audio-based user interface that allows a user to verbally confirm, deny, adjust, add, or remove labels during operation.

EEE(184) The medium according to any one of EEE(159) to EEE(183), wherein the user interface is configured to trigger sending the image data and the label a user or a plurality of users when an “usure” prompt is selected.

EEE(185) The medium according to any one of EEE(159) to EEE(184), wherein the user interface comprises a display.

EEE(186) The medium according to any one of EEE(159) to EEE(185), wherein a pipe is displayed one-dimensionally via the user interface and as substantially straight except at a joint.

EEE(187) The medium according to any one of EEE(159) to EEE(186), wherein the user interface is configured to display a 3D representation of a pipe via stitching that is performed using a SLAM technique with the image data.

EEE(188) The medium according to any one of EEE(159) to EEE(187), wherein the user interface is configured to display a 2D representation of a pipe that includes a constant diameter pipe, and wherein the 2D representation of the pipe is “unrolled” to a 1D image.

EEE(189) The medium according to any one of EEE(159) to EEE(188), wherein the set of functions further comprise providing a notification based on the classification or the label.

EEE(190) The medium according to any one of EEE(159) to EEE(189), wherein the notification includes an email, a text message, or a phone call.

EEE(191) The medium according to any one of EEE(159) to EEE(190), wherein the notification includes an audio notification, a haptic notification, or a visual notification.

EEE(192) The medium according to any one of EEE(159) to EEE(191), wherein the visual notification is provided through the user interface to highlight the aspect or the label within the image data.

EEE(193) The medium according to any one of EEE(159) to EEE(192), wherein the visual notification includes a screen flash, a highlighted border, or a pop-up.

EEE(194) The medium according to any one of EEE(159) to EEE(193), wherein the user interface provides a cropped video or compressed video based on the classification and the image data.

EEE(195) The medium according to any one of EEE(159) to EEE(194), wherein the area of interest includes a pipe and wherein the aspect is a crack, a clog, a root, a buildup of fluid, running fluid, pipe wear, a transition, a connecting pipe, a joint, a misalignment, an inner lining, a belly, a leak, a pipe material or type, a wire, a stud, a nail, daylight, a hoses, an outlet, a screw, a junction boxes, daylight, an item of interest, or a path aspect.

EEE(196) The medium according to any one of EEE(159) to EEE(195), wherein the path aspect includes a turn, a connection with another pipe, or a slope.

EEE(197) The medium according to any one of EEE(159) to EEE(196), wherein the image data includes video data.

EEE(198) The medium according to any one of EEE(159) to EEE(197), wherein a frequency or resolution of frames in the image data is modified depending on a speed of traversal, recently identified aspects, or device settings.

EEE(199) The medium according to any one of EEE(159) to EEE(198), wherein the label is provided as metadata of the image data.

EEE(200) The medium according to any one of EEE(159) to EEE(199), wherein the label is associated with a frame, a group of frames, a timestamp, a depth or a location of the inspection camera at the time of collection, or a jobsite.

EEE(201) The medium according to any one of EEE(159) to EEE(200), wherein the location of the inspection camera is determined based on a positional detection device.

EEE(202) The medium according to any one of EEE(159) to EEE(201), wherein the location is determined based on signals provided by a locating sonde.

EEE(203) The medium according to any one of EEE(159) to EEE(202), wherein the location is determined based on GPS data.

EEE(204) The medium according to any one of EEE(159) to EEE(203), wherein the image data is reduced or down sampled from collected raw image data.

EEE(205) The medium according to any one of EEE(159) to EEE(204), wherein the electronic processor is housed within a mobile device or a server device.

EEE(206) The medium according to any one of EEE(159) to EEE(205), wherein the inspection camera and the user interface are housed within an inspection tool.

EEE(207) The medium according to any one of EEE(159) to EEE(206), wherein the inspection camera is housed within a first tool, and wherein the user interface is housed within a second tool.

EEE(208) The medium according to any one of EEE(159) to EEE(207), wherein the inspection camera, the user interface, and the electronic processor are housed within an inspection tool.

EEE(209) The medium according to any one of EEE(159) to EEE(208), wherein the inspection tool comprises a drain cleaning tool, a pipe lining tool, pipe cleaning tool, a pipe internal welding tool, or a pipe internal cutting tool.

EEE(210) The medium according to any one of EEE(159) to EEE(209), wherein the inspection tool includes a microphone, an inductive sensor, a capacitive sensor, a magnetometer, a temperature sensor, a humidity sensor, an electrical contact sensor, a motion sensor, extension sensor, inertial measurement unit, or a camera module.

EEE(211) The medium according to any one of EEE(159) to EEE(210), wherein the camera module includes the inspection camera, and wherein the camera module is self-leveling and orients toward the bottom of a pipe.

EEE(212) The medium according to any one of EEE(159) to EEE(211), wherein the classification is determined by processing audio signals broadcast into the area of interest through the model along with or instead of the image data.

EEE(213) An inspection tool comprising: a housing; a user interface supported by the housing; an inspection reel supported by the housing and comprising an inspection camera configured to capture image data; and a controller comprising a processor and a memory, the controller supported by the housing and coupled to the inspection camera and the user interface, wherein the processor is configured to: receive, from the inspection camera, image data collected from an area of interest, process the received image data through a model to determine a classification for an aspect of the area of interest, the model trained with previously received image data and respective previously received or determined classifications, determine, based on the classification and the received image data, a command to control the inspection camera, and provide the command to the inspection camera.

EEE(214) The inspection tool according to EEE(213), wherein the model includes a histogram of pixel colors, shades, or saturations, mapped to a logical block.

EEE(215) The inspection tool according to any one of EEE(213) or EEE(214), wherein the logical block includes crude logic, a CNN, a DNN, an RNN, a random forest algorithm, a decision tree algorithm, a KNN algorithm, or a logistic regression algorithm.

EEE(216) The inspection tool according to any one of EEE(213) to EEE(215), wherein the classification is determine based on a distribution of color or brightness.

EEE(217) The inspection tool according to any one of EEE(213) to EEE(216), wherein the model comprises a computer vision algorithm.

EEE(218) The inspection tool according to any one of EEE(213) to EEE(217), wherein the computer vision algorithm includes SIFT, SURF, or ORB.

EEE(219) The inspection tool according to any one of EEE(213) to EEE(218), wherein the classification is determined based on a binary decision, a decision among multiple classifications, a multiple classification problem, or a visual classification problem.

EEE(220) The inspection tool according to any one of EEE(213) to EEE(219), wherein the command includes at least one of slowing a frame rate of the image data, providing a user prompt to the user interface, reduce a forward speed of the inspection tool, stopping a forward progression of the inspection tool, performing a zoom function with the inspection camera, panning the inspection camera, rotating the inspection camera, switching cameras, adjusting coloring, adjusting lighting, adjusting contrast, adjusting resolution, adjusting brightness, adjusting color mapping, or augmenting a visualization the aspect on the user interface.

EEE(221) The inspection tool according to any one of EEE(213) to EEE(220), wherein augmenting the visualization includes highlighting, magnifying, or adding a border surrounding the aspect.

EEE(222) The inspection tool according to any one of EEE(213) to EEE(221), wherein the augmentation of the visualization is saved as part of a video, saved in another layer, saved as metadata for a video, or saved in a separate file.

EEE(223) The inspection tool according to any one of EEE(213) to EEE(222), wherein the area of interest includes a pipe and wherein the aspect is a crack, a clog, a root, a buildup of fluid, running fluid, pipe wear, a transition, a connecting pipe, a joint, a misalignment, an inner lining, a belly, a leak, a pipe material or type, a wire, a stud, a nail, daylight, a hoses, an outlet, a screw, a junction boxes, daylight, an item of interest, or a path aspect.

EEE(224) The inspection tool according to any one of EEE(213) to EEE(223), wherein the path aspect includes a turn, a connection with another pipe, or a slope.

EEE(225) The inspection tool according to any one of EEE(213) to EEE(224), wherein the image data includes video data.

EEE(226) The inspection tool according to any one of EEE(213) to EEE(225), wherein a frequency or resolution of frames in the image data is modified depending on a speed of traversal, recently identified aspects, or device settings.

EEE(227) The inspection tool according to any one of EEE(213) to EEE(226), wherein the processor is further configured to: determine, based on the classification, a label for the aspect, and provide the label and received image data to the user interface.

EEE(228) The inspection tool according to any one of EEE(213) to EEE(227), wherein the model is retrained with the image data and the determined classification.

EEE(229) The inspection tool according to any one of EEE(213) to EEE(228), wherein the model is retrained with a selection, provided to through the user interface, to apply or not apply the label to the aspect.

EEE(230) The inspection tool according to any one of EEE(213) to EEE(229), wherein the selection includes metadata identifying a particular user, and wherein the model is trained and personalized for the particular user.

EEE(231) The inspection tool according to any one of EEE(213) to EEE(230), wherein the model is trained based on a distributed learning technique that merges a plurality of trainings from multiple users.

EEE(232) The inspection tool according to any one of EEE(213) to EEE(231), wherein the multiple users are assigned weights, and wherein the model is trained according to the assigned weights and respective trainings.

EEE(233) The inspection tool according to any one of EEE(213) to EEE(232), wherein the label is determined by processing the classification and the image data through a second model trained with the previously received image data, the respective previously received or determined classifications, and the respective previously received or determined labels.

EEE(234) The inspection tool according to any one of EEE(213) to EEE(233), wherein the second model is retrained with the image data, the determined classification, and the determined label.

EEE(235) The inspection tool according to any one of EEE(213) to EEE(234), wherein the processor is further configured to determine, based on an output filter and by processing the image data through the model, a confidence metric for the classification, and provide the confidence metric to the user interface.

EEE(236) The inspection tool according to any one of EEE(213) to EEE(235), wherein the output filter includes a number of consecutive frames that the classification is determined for the aspect.

EEE(237) The inspection tool according to any one of EEE(213) to EEE(236), wherein the user interface is configured to not display the label based on the confidence metric and a threshold value.

EEE(238) The inspection tool according to any one of EEE(213) to EEE(237), wherein the threshold value is customized for a user via the user interface.

EEE(239) The inspection tool according to any one of EEE(213) to EEE(238), wherein the user interface is configured to apply the label to the image data.

EEE(240) The inspection tool according to any one of EEE(213) to EEE(239), wherein the user interface is configured to provide a prompt to confirm, deny, adjust, add, or remove the label.

EEE(241) The inspection tool according to any one of EEE(213) to EEE(240), wherein the user interface includes an audio-based user interface that allows a user to verbally confirm, deny, adjust, add, or remove labels during operation.

EEE(242) The inspection tool according to any one of EEE(213) to EEE(241), wherein the user interface is configured to trigger sending the image data and the label a user or a plurality of users when an “usure” prompt is selected.

EEE(243) The inspection tool according to any one of EEE(213) to EEE(242), wherein the user interface comprises a display.

EEE(244) The inspection tool according to any one of EEE(213) to EEE(243), wherein a pipe is displayed one-dimensionally via the user interface and as substantially straight except at a joint.

EEE(245) The inspection tool according to any one of EEE(213) to EEE(244), wherein the user interface is configured to display a 3D representation of a pipe via stitching that is performed using a SLAM technique with the image data.

EEE(246) The inspection tool according to any one of EEE(213) to EEE(245), wherein the user interface is configured to display a 2D representation of a pipe that includes a constant diameter pipe, and wherein the 2D representation of the pipe is “unrolled” to a 1D image.

EEE(247) The inspection tool according to any one of EEE(213) to EEE(246), wherein the processor is further configured to provide a notification based on the classification, the label, or the command.

EEE(248) The inspection tool according to any one of EEE(213) to EEE(247), wherein the notification includes an email, a text message, or a phone call.

EEE(249) The inspection tool according to any one of EEE(213) to EEE(248), wherein the notification includes an audio notification, a haptic notification, or a visual notification.

EEE(250) The inspection tool according to any one of EEE(213) to EEE(249), wherein the visual notification is provided through the user interface to highlight the aspect or the label within the image data.

EEE(251) The inspection tool according to any one of EEE(213) to EEE(250), wherein the visual notification includes a screen flash, a highlighted border, or a pop-up.

EEE(252) The inspection tool according to any one of EEE(213) to EEE(251), wherein the user interface provides a cropped video or compressed video based on the classification and the image data.

EEE(253) The inspection tool according to any one of EEE(213) to EEE(252), wherein the label is provided as metadata of the image data.

EEE(254) The inspection tool according to any one of EEE(213) to EEE(253), wherein the label is associated with a frame, a group of frames, a timestamp, a depth or a location of the inspection camera at the time of collection, or a jobsite.

EEE(255) The inspection tool according to any one of EEE(213) to EEE(254), wherein the location of the inspection camera is determined based on a positional detection device.

EEE(256) The inspection tool according to any one of EEE(213) to EEE(255), wherein the location is determined based on signals provided by a locating sonde.

EEE(257) The inspection tool according to any one of EEE(213) to EEE(256), wherein the location is determined based on GPS data.

EEE(258) The inspection tool according to any one of EEE(213) to EEE(257), wherein the image data is reduced or down sampled from collected raw image data.

EEE(259) The inspection tool according to any one of EEE(213) to EEE(258), comprising a drain cleaning tool, a pipe lining tool, pipe cleaning tool, a pipe internal welding tool, or a pipe internal cutting tool.

EEE(260) The inspection tool according to any one of EEE(259) to EEE(215), comprising a microphone, an inductive sensor, a capacitive sensor, a magnetometer, a temperature sensor, a humidity sensor, an electrical contact sensor, a motion sensor, extension sensor, inertial measurement unit, or a camera module.

EEE(261) The inspection tool according to any one of EEE(213) to EEE(260), wherein the camera module includes the inspection camera, and wherein the camera module is self-leveling and orients toward the bottom of a pipe.

EEE(262) The inspection tool according to any one of EEE(213) to EEE(261), wherein the classification is determined by processing audio signals broadcast into the area of interest through the model along with or instead of the image data.

1-54. (canceled)

55. An inspection tool comprising:
a housing;
a user interface supported by the housing;
an inspection reel supported by the housing and including an inspection camera configured to captured image data;
a controller including a processor and a memory, the controller supported by the housing and coupled to the inspection camera and the user interface, wherein the processor is configured to:
receive, from the inspection camera, image data collected from an area of interest,
process the received image data through a model to determine a classification for an aspect of the area of interest, the model trained with previously received image data and respective previously received or determined classifications,
determine, based on the classification, a label for the aspect, and
provide the label and received image data to the user interface.

56-72. (canceled)

73. The inspection tool of claim 55, wherein the processor is further configured to:
determine, based on the classification and the image data, a command to control the inspection camera; and
provide the command to the inspection camera.

74. The inspection tool of claim 73, wherein the command includes at least one of slowing a frame rate of the image data, providing a user prompt to the user interface, reduce a forward speed of the inspection tool, stopping a forward progression of the inspection tool, performing a zoom function with the inspection camera, panning the inspection camera, rotating the inspection camera, switching cameras, adjusting coloring, adjusting lighting, adjusting contrast, adjusting resolution, adjusting brightness, adjusting color mapping, or augmenting a visualization the aspect on the user interface.

75-81. (canceled)

82. The inspection tool of claim 55, wherein a pipe is displayed one-dimensionally via the user interface and as substantially straight except at a joint.

83. The inspection tool of claim 55, wherein the user interface is configured to display a three-dimensional (3D) representation of a pipe via stitching that is performed using a simultaneous localization and mapping (SLAM) technique with the image data.

84. The inspection tool of claim 55, wherein the user interface is configured to display a two-dimensional (2D) representation of a pipe that includes a constant diameter pipe, and wherein the 2D representation of the pipe is “unrolled” to a one-dimensional (1D) image.

85-90. (canceled)

91. The inspection tool of claim 55, wherein the area of interest includes a pipe and wherein the aspect is a crack, a clog, a root, a buildup of fluid, running fluid, pipe wear, a transition, a connecting pipe, a joint, a misalignment, an inner lining, a belly, a leak, a pipe material or type, a wire, a stud, a nail, daylight, a hoses, an outlet, a screw, a junction boxes, daylight, an item of interest, or a path aspect.

92. The inspection tool of claim 91, wherein the path aspect includes a turn, a connection with another pipe, or a slope.

93-104. (canceled)

105. A method for determining a classification from image data, the method comprising:
receiving, from an inspection camera, image data collected from an area of interest;
processing the image data through a model to determine a classification for an aspect of the area of interest, the model trained with previously received image data and respective previously received or determined classifications;
determining, based on the classification, a label for the aspect; and
providing the label and image data to a user interface.

106-122. (canceled)

123. The method of claim 105, further comprising:
determining, based on the classification and the image data, a command to control the inspection camera; and
providing the command to the inspection camera or an inspection tool housing the inspection camera.

124. The method of claim 123, wherein the command includes at least one of slowing a frame rate of the image data, providing a user prompt to the user interface, reduce a forward speed of the inspection tool, stopping a forward progression of the inspection tool, performing a zoom function with the inspection camera, panning the inspection camera, rotating the inspection camera, switching cameras, adjusting coloring, adjusting lighting, adjusting contrast, adjusting resolution, adjusting brightness, adjusting color mapping, or augmenting a visualization the aspect on the user interface.

125-131. (canceled)

132. The method of claim 105, wherein a pipe is displayed one-dimensionally via the user interface and as substantially straight except at a joint.

133. The method of claim 105, wherein the user interface is configured to display a three-dimensional (3D) representation of a pipe via stitching that is performed using a simultaneous localization and mapping (SLAM) technique with the image data.

134. The method of claim 105, wherein the user interface is configured to display a two-dimensional (2D) representation of a pipe that includes a constant diameter pipe, and wherein the 2D representation of the pipe is “unrolled” to a one-dimensional (1D) image.

135-140. (canceled)

141. The method of claim 105, wherein the area of interest includes a pipe and wherein the aspect is a crack, a clog, a root, a buildup of fluid, running fluid, pipe wear, a transition, a connecting pipe, a joint, a misalignment, an inner lining, a belly, a leak, a pipe material or type, a wire, a stud, a nail, daylight, a hoses, an outlet, a screw, a junction boxes, daylight, an item of interest, or a path aspect.

142. The method of claim 141, wherein the path aspect includes a turn, a connection with another pipe, or a slope.

143-212. (canceled)

213. An inspection tool comprising:
a housing;
a user interface supported by the housing;
an inspection reel supported by the housing and including an inspection camera configured to capture image data; and
a controller including a processor and a memory, the controller supported by the housing and coupled to the inspection camera and the user interface, wherein the processor is configured to:
receive, from the inspection camera, image data collected from an area of interest,
process the received image data through a model to determine a classification for an aspect of the area of interest, the model trained with previously received image data and respective previously received or determined classifications,
determine, based on the classification and the received image data, a command to control the inspection camera, and
provide the command to the inspection camera.

214-219. (canceled)

220. The inspection tool of claim 213, wherein the command includes at least one of slowing a frame rate of the image data, providing a user prompt to the user interface, reduce a forward speed of the inspection tool, stopping a forward progression of the inspection tool, performing a zoom function with the inspection camera, panning the inspection camera, rotating the inspection camera, switching cameras, adjusting coloring, adjusting lighting, adjusting contrast, adjusting resolution, adjusting brightness, adjusting color mapping, or augmenting a visualization the aspect on the user interface.

221. The inspection tool of claim 220, wherein augmenting the visualization includes highlighting, magnifying, or adding a border surrounding the aspect.

222. The inspection tool of claim 220, wherein the augmentation of the visualization is saved as part of a video, saved in another layer, saved as metadata for a video, or saved in a separate file.

223-262. (canceled)
